(19) United States
(12) Patent Application Publication
(10) Pub. No.: US 2023/0306390 A1
(43) Pub. Date: Sep. 28, 2023

(54) Systems and Methods for Creating and Utilizing Tokens Containing a Backing Component

(71) Applicants: Faiz Ahmed, Toronto (CA); Saloni Agarwal, Somerville, MA (US)

(72) Inventors: Faiz Ahmed, Toronto (CA); Saloni Agarwal, Somerville, MA (US)

(21) Appl. No.: 18/188,090

(22) Filed: Mar. 22, 2023

Related U.S. Application Data
(60) Provisional application No. 63/269,776, filed on Mar. 22, 2022.

(51) Int. Cl. G06Q 20/10; G06Q 20/08; G06Q 20/38

(52) U.S. Cl. CPC G06Q 20/10; G06Q 20/0855; G06Q 20/382

(57) ABSTRACT

Embodiments of the present disclosure provide methods, systems, and computer program products that facilitate the creation, sale, transfer, and exchange of tokens with a backing component on a platform. The method includes obtaining a digital asset for conversion to a token. The digital asset is a non-fungible token (NFT). The method also includes collecting a backing component for the digital asset and creating a smart contract associated with the digital asset. The smart contract links the backing component for the digital asset. The method further includes generating the token via tokenization of the digital asset and the smart contract. Embodiments of the disclosure include token that include backing components that are physical assets and banking mechanisms that are retrievable when predetermined criteria are achieved.

### CROSS-REFERENCE TO RELATED APPLICATIONS

This application claims priority to U.S. Provisional Patent Application No. 63/269,776, filed Mar. 22, 2022, and titled “System and Method for Solitaire Token”, the entire contents of which are incorporated herein by reference.

### BACKGROUND

The present disclosure relates to non-fungible tokens (NFTs) and, more specifically, to facilitating the sale, modification, and exchange of NFTs backed by a backing component such as a physical asset and/or digital currency.

Digital assets are a type of asset that exists in digital form and can be accessed and transferred through digital networks, such as the Internet. Examples of digital assets include, but are not limited to, cryptocurrencies, digital tokens, digital art, domain names, software, and digital media. The ownership and transfer of such digital assets are typically managed through distributed ledgers, such as blockchain technology, which allows for secure and transparent transactions.

Distributed ledgers are a type of database that is spread across a network of computers or nodes, allowing multiple parties to access and update the ledgers without the need for a central authority or inter01mediary. The ledger records transactions or other data using a consensus mechanism to ensure that all nodes on the network agree on the contents of the ledger. As a result, any changes to the ledger must be approved by a majority of the nodes on the network.

### SUMMARY

Introduced here is a platform that uses techniques/technologies to facilitate the creation, sale, transfer, modification, and/or exchange of non-fungible tokens that include backing components. The backing components can include physical assets and banking mechanisms used either separately or in combination selected during creation. These non-fungible tokens with backing components can be considered solitaire tokens (ST). The platform allows for the creation of ST tokens, the sale of ST tokens, the modification of ST tokens, and the retrieval of assets associated with ST tokens when certain predefined criteria are met and/or when the destruction of the ST token occurs.

Embodiments of the present disclosure are directed to providing mechanisms, including methods and computer program products for using ST tokens via an ST platform, including the creation, sale, modification, and exchange of ST tokens by users on the ST platform. Methods for creating ST tokens include obtaining a digital asset for conversion to an ST token. The digital asset can be a digital work provided by a program organizer. The method also includes collecting a backing component for the digital asset and creating a smart contract associated with the digital asset. The smart contract links the backing component for the digital asset. The method further includes generating the ST token via tokenization of the digital asset, the backing component, and the smart contract.

Additional embodiments of the present disclosure include a computer program product for retrieval of a backing component associated with a solitaire token (ST), the computer program product comprising a computer-readable storage medium having computer-readable instructions stored therein, wherein the computer-readable instructions, when executed on a computing device, causes the computing device to receive a request from an owner of an ST token, wherein the request relates to retrieval of a backing component associated with the ST token. The instructions also cause the computing device to verify that a retrieval requirement set forth in a smart contract associated with the ST token is achieved, to destroy the ST token, to retrieve an asset acting as the backing component for the ST token, and to provide the asset to the owner.

This summary is intended to introduce a selection of concepts in a simplified form that is further described in the detailed description section of this disclosure. The summary is not intended to identify key or essential features of the claimed subject matter, nor is it intended as an aid in determining the scope of the claimed subject matter. Additional objects, advantages, and novel features of the technology will be set forth in part in the description that follows and, in part, will become apparent to those skilled in the art upon examination of the disclosure or learned through practice of the technology.

### BRIEF DESCRIPTION OF THE DRAWINGS

These and other features, aspects, and advantages of the embodiments of the disclosure will become better understood with regard to the following description, appended claims, and accompanying drawings where:

FIG. 1 illustrates a diagram of an ST platform environment, in accordance with embodiments of the present disclosure.

FIG. 2 illustrates a diagram of an ST platform for creating solitaire tokens and facilitating the sale, modification, and exchange of the ST tokens, in accordance with embodiments of the present disclosure.

FIG. 3 illustrates an exemplary physical ST token creation workflow, in accordance with embodiments of the present disclosure.

FIG. 4 illustrates an exemplary complete ST token creation workflow, in accordance with embodiments of the present disclosure.

FIG. 5 illustrates an exemplary bank ST token creation workflow, in accordance with embodiments of the present disclosure.

FIG. 6 illustrates an exemplary second-hand sale of a complete ST token on the ST platform, in accordance with embodiments of the present disclosure.

FIG. 7 illustrates an exemplary destruction of an ST token on the ST platform workflow, in accordance with embodiments of the present disclosure.

FIG. 8 illustrates a digital asset addition mechanism offered by a hybrid ST token of the ST platform, in accordance with embodiments of the present disclosure.

FIG. 9 illustrates a digital asset addition mechanism offered by a hybrid ST token of the ST platform, in accordance with embodiments of the present disclosure.

FIG. 10 illustrates a digital asset upgrade mechanism offered by a hybrid ST token of the ST platform, in accordance with embodiments of the present disclosure.

FIG. 11 illustrates a physical asset addition mechanism offered by a hybrid ST token on the ST platform, in accordance with embodiments of the present disclosure.

FIG. 12 illustrates a physical asset upgrade mechanism offered by a hybrid ST token on the ST platform, in accordance with embodiments of the present disclosure.

FIG. 13-15 illustrate various configurations of a hybrid ST token, in accordance with embodiments of the present disclosure.

FIG. 16 illustrates a method 1600 of a series of acts in a method of creating an ST token from a digital asset and backing component provided by a user to an ST platform, in accordance with embodiments of the present disclosure.

FIG. 17 illustrates a method 1700 of a series of acts in a method of facilitating a sale of an ST token between a buyer and a seller operating within an ST platform, in accordance with embodiments of the present disclosure.

FIG. 18 illustrates a method 1800 of a series of acts in a method of facilitating a retrieval of backing components of an ST token by destroying the ST token, in accordance with embodiments of the present disclosure.

FIG. 19 illustrates a schematic diagram of an exemplary environment in which a ST platform environment and ST platform server can operate, in accordance with embodiments of the present disclosure.

FIG. 20 illustrates a block diagram of an exemplary computing device, in accordance with an embodiment described herein.

While the present disclosure is amenable to various modifications and alternative forms, specifics thereof, have been shown by way of example in the drawings and will be described in detail. It should be understood, however, that the intention is not to limit the particular embodiments described. On the contrary, the intention is to cover all modifications, equivalents, and alternatives falling within the scope of the present disclosure. Like reference numerals are used to designate like parts in the accompanying drawings.

### DETAILED DESCRIPTION

The present disclosure relates to non-fungible tokens (NFTs) and, more specifically, to facilitating the sale, modification, and exchange of NFTs backed by a backing component such as a physical asset and/or digital currency. While the present disclosure is not necessarily limited to such applications, various aspects of the disclosure may be appreciated through a discussion of various examples using this context.

### Overview

Digital assets can include any information that can be stored, transmitted, interpreted, and encoded in a numeric format (e.g., binary data). Currently, the majority of digital assets are stored in binary format, but as technology progresses, other non-binary forms (e.g., quantum data) of encoding and storage may be developed and used to create digital assets. Types of digital assets include, but are not limited to, digital documents, digital art, encoded audio, encoded video, encoded text, executable code, and the like.

An NFT is a unique digital asset that is stored on a distributed ledger (e.g., blockchain) and represents ownership of a specific digital asset, such as a piece of artwork, a video, or a collectible. Unlike fungible tokens, such as cryptocurrencies, which are interchangeable and have the same value, each NFT is unique and thus, is not interchangeable.

NFTs are created by minting them on a distributed ledger, such as a blockchain, which establishes a verifiable and immutable record of ownership. Each NFT contains metadata that describes the asset it represents, including its origin, history, and ownership. This metadata is stored on the distributed ledger, allowing anyone to verify the authenticity and ownership of the as set.

A key feature of NFTs is that they allow digital creators to monetize their work in new ways. By creating and selling NFTs of their artwork, music, or other digital assets, creators can retain ownership and control over their work while also allowing others to own unique and verifiable digital assets. NFTs also create a new market for collectors and investors, who can buy, sell, and trade unique digital assets on blockchain-based marketplaces.

In some instances, blockchain smart contracts are used to facilitate the exchange and sale of NFTs between parties. A blockchain smart contract, or smart contract, is a self-executing program or code that is stored on a blockchain and automatically enforces the terms of an agreement between parties. Smart contracts are designed to be autonomous and operate based on pre-programmed rules and conditions. Once these conditions are met, the smart contract is automatically executed, and the agreed-upon transaction is completed. Smart contracts are often used in decentralized application (dApps) that run on blockchain platforms, such as Ethereum. These dApps can be used for a variety of purposes, including financial transactions, supply chain management, and voting systems.

NFT smart contracts are created using a blockchain platform that supports the creation and transfer of NFTs. During creation, the smart contract code can define certain rules for the creation, ownership, and transfer of an NFT, including its metadata and any conditions or restrictions on its use. During an exchange (e.g., buy, sale, transfer) of an NFT, the smart contract code can be used to ensure that the terms of the transaction are met and that ownership of the NFT is securely transferred between parties.

Limitations on the exchange of NFTs between parties remain, however, as NFTs have been known to experience volatility, which is the degree of variation in their price over time. Like other digital assets, NFTs can experience rapid fluctuations in value due to changes in market demand, perceived value, and other factors. The volatility of NFTs can be attributed to various factors, such as the popularity of the artist or creator behind the NFT, the rarity of the digital asset, and the hype surrounding the NFT marketplace. As such, NFTs can experience sudden spikes in value when they gain widespread attention, and their value can also rapidly decrease if market demand decreases or if there is an oversupply of similar NFTs. Due to the volatility, NFTs are considered a risky investment for individuals looking for a stable or predictable return.

Embodiments of the present disclosure improve the existing technologies described herein (as well as others) by providing a novel NFT platform that facilitates the creation and exchange of NFTs backed by either a physical asset or currency stored in escrow (“piggy bank”), or both. As referred herein, such NFTs with backing can be considered solitaire tokens (ST). As such, embodiments of the present disclosure describe an ST platform configured to provide for the creation, sale, trade, modification, transfer, or otherwise the exchange of ST tokens on the ST platform.

More specifically, embodiments improve upon existing technologies by developing novel NFTs backed by physical assets and currency stored in escrow. The ST platform can host ST tokens, which can include different combinations of digital assets and physical assets. Information regarding the ST tokens can also be retrieved via the ST platform. This information includes, but is not limited to, primary sale listing price, transaction history, references to each respective digital and physical asset, NFT metadata, and the like. New ST tokens can be released and sold as a primary sale (e.g., sale from the first listing) on the ST platform. Following the sale, the ST tokens can be traded between users on the ST platform. Any subsequent sale can be considered a secondary sale, and such sales can be documented within the information stored on each respective ST token.

In some embodiments, the ST platform provides a physical ST token. A physical ST token can be a type of NFT that is backed by a physical asset. A physical asset can be any tangible item that has an inherent value and can be used or consumed to generate income or serve a particular purpose. For example, physical assets include real estate, commodities (e.g., oil, natural gas, precious gems), collectibles, machinery, precious metals (e.g., gold, silver, platinum, etc.), and inventory.

In some embodiments, a user is required to burn their physical ST in order to redeem the physical asset associated with the physical ST. “Burning” an NFT, or ST, refers to the act of permanently and irreversibly destroying an NFT, or ST, by sending it to an address that is not retrievable. It should be noted that burning describes the process of digitally destroying the token and not physically burning an object. For example, burning the ST can be performed by assigning the ownerAddress field stored in the ST's smart contract to a ‘null’ wallet address. In another example, burning an ST can be performed by enabling an unchangeable method in the ST's smart contract making the contract immutable and unchangeable.

In some embodiments, the ST platform provides complete ST tokens backed by both a physical asset and a banking mechanism. The banking mechanism is configured to provide a digital, or physical, container for storing funds held in escrow by the ST platform or other third-party provider. In some embodiments, a predefined percentage of the sale price of a complete ST is deposited into the banking mechanism each time a sale of the complete ST occurs. For example, a complete ST token sale of $10,000 occurs, and 10% of that sale is deposited into the banking mechanism and stored. It should be noted that the percentage of funds being deposited into the banking mechanism can come directly from the sale price (e.g., 100%-10%) or can be added to the sale price (e.g., 100%+10%). In some embodiments, a smart contract, either external or the smart contract associated with the complete ST token, holds the value in the contract. For example, the banking mechanism can be written to contain a clause that stores the funds. In some embodiments, the funds are stored by the ST platform or other third-party providers. For example, the funds can be stored in a vault operated by the ST platform.

In some embodiments, a user is required to burn their complete ST token in order to redeem the physical asset and/or the funds associated with the complete ST token. Similar to the physical ST token, the burning process destroys the complete ST token in similar manners described above.

In some embodiments, the ST platform provides bank ST tokens backed by a banking mechanism. Similar to the complete ST, the banking mechanism of the bank ST tokens is configured to provide a digital container for storing funds that are held in escrow by the ST platform or other third-party providers. In some embodiments, a predefined percentage of the sale price of a complete ST is deposited into the banking mechanism each time a sale of the bank ST token occurs. In some embodiments, in order to access and retrieve the funds stored in the banking mechanism, a user is required to burn the bank ST token, thereby destroying the bank ST token.

The techniques and embodiments described herein provide various technical improvements over conventional methods of selling, buying, modifying, transferring, or otherwise exchanging NFTs. For example, embodiments that provide a mechanism for facilitating the creation and operation of ST tokens (e.g., physical ST tokens, complete ST tokens, bank ST tokens, etc.) provide internal components (e.g., physical assets, banking mechanisms) that facilitate greater exchange flexibility by utilizing the assets as backings for the ST tokens. These mechanisms provide users with assurance during the sale, transfer, or exchange of ST tokens not provided by conventional methods. Additionally, these mechanisms also provide investment tools for each ST token by providing techniques that allow users to apply additional physical assets and/or funds to an ST token. Furthermore, embodiments describing techniques to apply additional NFTs to an existing ST further provide improved investment techniques over conventional NFTs such that users can continuously increase the value of their ST token when predefined criteria are achieved.

### Example Solitaire Token Platform Environment

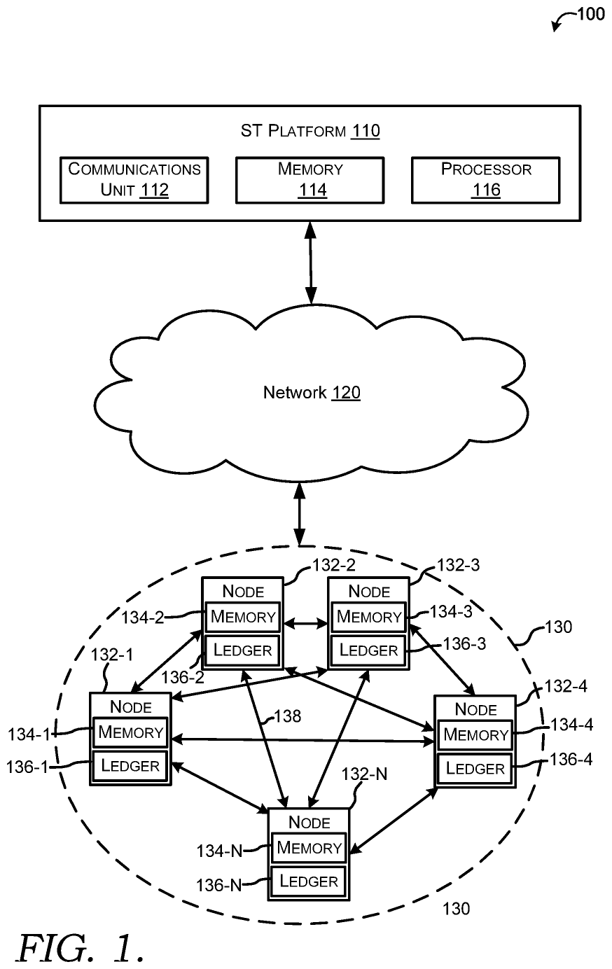

FIG. 1 is a block diagram of an ST platform environment 100 for facilitating the sale, trade, modification, transfer, and exchange of ST tokens between users, in accordance with embodiments of the present disclosure. The ST platform environment 100 includes an ST platform server 110, a network 120, and a blockchain network 130. The blockchain network 130 includes nodes 132-1, 132-2, 132-3, 132-4, 132-N (collectively “nodes 132”), where N is a variable integer representing any number of possible nodes 132, where the nodes 132 are communicatively coupled with one another via communication pathways 206 (e.g., wired or wireless network connections, over the Internet, etc.) to transmit and receive data related to the ledger 236. Each node 132 includes a memory 134 and a ledger 136, with a corresponding variable integer designating the specific node 132.

The ST platform server 110 is a component of the ST platform environment 100 configured to generate ST tokens and to facilitate the sale, modification, transfer, and exchange of the ST tokens between users. In some embodiments, the ST platform server 110 includes a communication unit 112, a memory 114, and a processor 116. The communications unit 112 is configured to handle electronic communications with the blockchain network 130 via the network 120. The processor 116 is configured to perform the methods and techniques described herein, as well as any operational processes required to facilitate the creation of ST tokens and also the sale, transfer, and exchange of those ST tokens. The memory 114 is configured to store instructions that perform the methods and techniques described herein. It should be noted that the ST platform server 100 is described in this manner for illustrative purposes only. Other embodiments where the ST platform server 110 includes an integrated processor in which a medium, a processor, and a memory are integrated and configured to perform the embodiments described herein are not excluded.

In some embodiments, the ST platform server 110 supports users to access the nodes 132 of the blockchain network 130. For example, the ST platform server 110 can perform the role of mediating a connection to a node 132 by transmitting a front-end code to a user or may perform the role of directly connecting a user and nodes 132. Hereinafter, for convenience of description, the ST platform server 110 is described as managing both the issuance and transaction of ST tokens between users. It should be noted, however, that other server configurations may exist that may perform the issuance and transaction of ST tokens without departing from the scope of the disclosure.

The components of the ST platform environment 100 are communicatively coupled via the network 120. In some embodiments, the network 120 includes one or more local area networks (LANs), wide area networks (WANs), and/or other networks. In some implementations, the communication path provided by the network 120 is point-to-point over public and/or private networks. The communication is capable of occurring over a variety of networks, including private networks, a virtual private network (“VPN”), multiprotocol label switching (“MPLS”) circuit, or the Internet, and uses appropriate application programming interfaces (APIs) and data interchange formats such as Representational State Transfer (REST), JavaScript Object Notation (JSON), Extensible Markup Language (XML), Simple Object Access Protocol (SOAP), Java Message Service (JMS), and/or Java Platform Module System.

In some embodiments, communication is encrypted. The communication is generally over a network such as the LAN, WAN, telephone network (Public Switched Telephone Network (PSTN), Session Initiation Protocol (SIP), wireless network, point-to-point network, star network, token ring network, hub network, Internet, inclusive of the mobile Internet, via protocols such as EDGE, 3G, 4G LTE, 5G, W-Fi and WiMAX.

The blockchain network 130 is a component of the ST platform environment 100 configured to manage blockchains stored in a decentralized manner on the plurality of nodes 132 (e.g., computing devices located in one or more networks). Blockchains can include a plurality of data blocks where each data block represents a data structure that includes data representing transactions. As new transactions are submitted to the blockchain and validated by the nodes 132, or validator nodes, additional data blocks are generated by the nodes 132 and appended to the blockchain. Each new data block can include a set of validated transactions and a hash of the content of the immediately previous data block. For example, data block “2” includes a hash of the content of data block “1”, block “N” includes a hash of the content of block “N−1”, etc. Some examples of blockchains include, but are not limited to, Bitcoin®, Ethereum®, OpenLedger®, or other similar blockchains.

In some embodiments, blockchains are stored in a decentralized manner on the plurality of nodes 132. Each node 132 can include a memory 134 that stores at least a portion of a ledger 136 of the blockchains. The ledgers 136 include any data blocks that have been validated and added to the blockchain. In some embodiments, every node 132 may store the entire ledger 136. In some embodiments, each node 132 may store a portion of the ledger 136. In some embodiments, some or all of the blockchain may be stored in a centralized manner. The nodes 132 may communicate with one another via the communication pathways 138 (e.g., wired or wireless connections, over the Internet, etc.) to transmit and receive data related to the ledger 136. For example, as new data blocks are added to the ledger 136, the nodes 132 may communicate or share the new data blocks via the communication pathways 138.

In some embodiments, any transaction submitted to the blockchain is validated by a set of validator nodes (not shown) associated with the blockchain. For example, transactions may be transmitted to one or more validator nodes and can be shared between the validator nodes for validation and consensus. Each validator node can determine whether a transaction (e.g., the sale, transfer, or exchange of ST tokens) is valid and whether the transaction complies with the rules of the blockchain. The validator nodes add a plurality of validated transactions to the data blocks and submit the data blocks for consensus by all or some of the other validator nodes. The other validator nodes can then vote “for” or “against” appending the data blocks containing the transactions to the blockchain. A consensus of the set of validator nodes (e.g., a threshold number of identical votes “for” or “against”) is required to allow or deny the data blocks to be appended to the blockchain. In some embodiments, the nodes 132 act as validator nodes and perform the validation process directly. In some embodiments, the nodes 132 are not validator nodes and only perform processing such as receiving transaction submissions, providing member services, handling application programming interface (API) requests from users, or other similar functions. In this manner, the processing power of the validator nodes can be preserved for generating new blocks, reaching consensus, and monitoring the other validator nodes. The validator nodes can communicate with one another via the communication pathways 138 (e.g., wired or wireless connections, over the Internet, etc.) to transmit and receive data. For example, as new data blocks are generated by validator nodes, the validator nodes can communicate or share the new data blocks and transmit and receive consensus messages via the communication pathways 138.

It is noted that FIG. 1 is intended to depict the major representative components of an ST platform environment 100. In some embodiments, however, individual components may have greater or lesser complexity than as represented in FIG. 1, components other than or in addition to those shown in FIG. 1 may be present, and the number, type, and configuration of such components may vary.

### Example Solitaire Token Platform

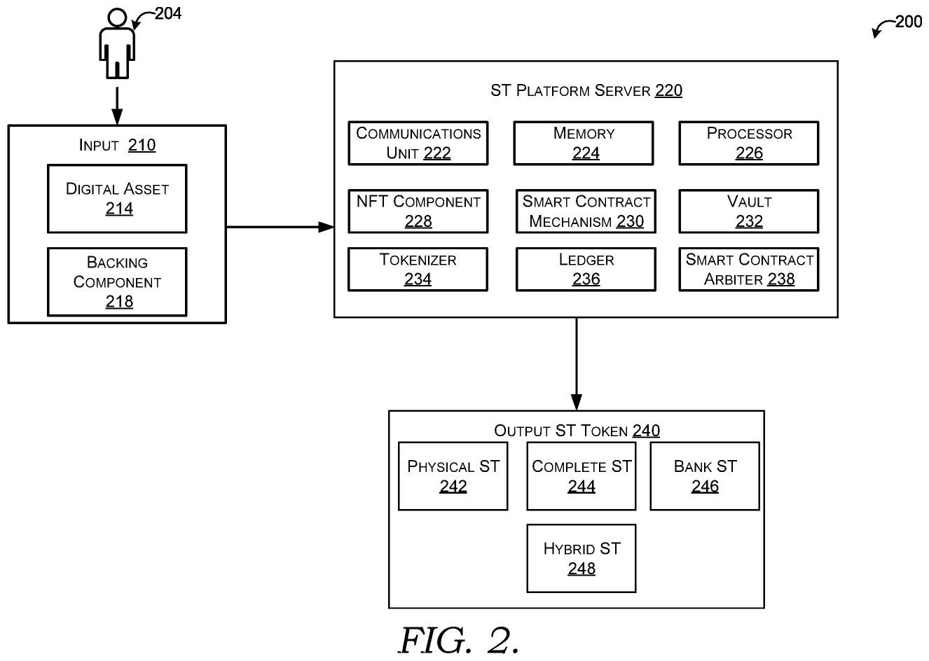

FIG. 2 is a block diagram illustrating an ST platform 200 configured to create ST tokens and to facilitate the sale, transfer, modification, and/or exchange of the ST tokens, in accordance with embodiments of the present disclosure. As discussed, embodiments use ST tokens and utilization methods to facilitate the creation, sale, modification, and exchange of NFTs with at least one backing component. As shown, the ST platform 200 includes input 210, an ST platform server 220, and output ST token 240. The input 210 includes a digital asset 214 and a backing component 218. The ST platform server 220 includes a communications unit 222, a memory 224, a processor 226, an NFT component 228, a smart contract mechanism 230, a vault 232, a tokenizer 234, and a ledger 236. The output includes a physical ST token 242, a complete ST token 244, a bank ST token 246, and a hybrid ST token 248. This combination of components enables the ST platform, through the ST platform server 220, to create, sell, modify, and exchange ST tokens between users on the ST platform 200.

The ST platform server 220 includes a communications unit 222, memory 224, a processor 226, an NFT component 228, the smart contract mechanism 230, a vault 232, a tokenizer 234, and the ledger 236. The communications unit 222 is configured to handle electronic communications with a blockchain network 130 via a network 120, as shown in FIG. 1. The processor 226 is configured to perform the methods and techniques described herein as well as any operational processes required to facilitate the creation of ST tokens and also the sale, transfer, modification, and exchange of those ST tokens. The memory 224 is configured to store instructions that perform the methods and techniques described herein. It should be noted that the ST platform 200 is described in this manner for illustrative purposes only. Other embodiments where the ST platform 200 includes an integrated processor in which a medium, a processor, and a memory are integrated and configured to perform the embodiments described herein are not excluded.

In some embodiments, the backing component 218 is a physical asset (e.g., precious gems, metals, real estate, commodities) which are placed in the vault 232. In some embodiments, the vault 232 is a physical vault that is accessible and managed by administrators of the ST platform 200. The physical assets can be stored in the vault 232 until the conditions stipulated in a smart contract are met, and at that time can then be provided to the owner of the ST token. In some embodiments, the vault 232 is managed by a third party in which the third party is referenced in the smart contract.

The ST platform 200 further supports services associated with offering modified NFTs in the form of ST tokens. In some embodiments, the content creator may elect to embody the value of one or more of their digital assets 214 in a non-fungible token. “Non-fungibility” refers to the uniqueness or non-interchangeability of individual units of an asset. For example, NFTs cannot be replaced with other tokens of the same type. An example format for an NFT on the Ethereum blockchain is a token standard referred to as ERC-721. The ERC-1155 standard offers semi-fungibility. Unlike ERC-721, where the unique identifier represents one asset, the unique identifier of the ER-1155 token represents a whole class of fungible assets, any number of which the user can transfer to others. Components based on the ERC-998 standard are the templates according to which NFTs can be either non-fungible or fungible assets. While Ethereum is a popular choice for NFT marketplaces, other NFT marketplaces exist as well, belonging to other blockchain networks like Cosmos, Polkadot, International Blockchain Consulting (IBC), Interledger, Binance Smart Chain, and the like. Similar to those marketplaces/platforms, the ST platform 200 offers specific instructions, standards, formats, and configurations for creating and utilizing ST tokens.

In order to create an ST token, the ST platform server 220 utilizes an NFT component 228 configured to generate (or mint) an NFT for one or more digital assets 214, according to user's preferences (e.g., specific blockchain, expiration time, transfer requirements, user's location (e.g., if it is detected that a user is operating in a wallet on a different blockchain)), and backing component 218. The NFT component 228 is further configured to capture a unique description of the digital asset 214 associated with the NFT.

The smart contract mechanism 230 is configured to create a smart contract used to govern the behavior of the NFT and subsequent ST tokens. For example, a smart contract can govern instances when the ST token can be transferred to another party or when media content can be divided into smaller portions, such as a sample, or when and how the digital asset is utilized. In some embodiments, the smart contract mechanism 230 also governs access restrictions to the backing component 218 associated with the ST token. For example, the smart contract may dictate that the backing component 218 may only be accessed when the ST token is destroyed or burned. In another example, the smart contract may dictate a percentage of the sale price of the ST token be placed into a banking mechanism, and those funds be stored in escrow until another requirement outlined in the smart contract is met or achieved.

In some embodiments, the smart contracts include requirements for a particular backing component 218. For example, the backing component 218 can be a banking mechanism that requires a certain monetary deposit for any transaction of the ST token to take place. This requirement may be outlined in the smart contract. For example, the smart contract may require a fixed percentage of the value of the ST token contemplated for a transaction. For each transaction, the banking mechanism may require a monetary deposit which effectively accumulates deposits with each transaction of the ST token.

In some embodiments, the ST platform server 220 includes a smart contract arbiter 238 configured to determine that one or more conditions referenced in a smart contract have been satisfied. The smart contract arbiter 238 can utilize smart contract chain code (e.g., such as a system chain code available in Hyperledger Fabric 1.0) to facilitate the determination of conditions being satisfied. The smart contract arbiter 238 is further configured to interpret and execute the code defining a smart contract. Through a plurality of smart contracts or chain code, the ledger 236 can maintain a consensus between different blockchains with relation to the user's wallets, underlying ST tokens, and backing components 218. The smart contract arbiter 238 is also configured to route incoming transactions to one of the blockchain(s) and enable the processing of the transaction on the blockchain.

The ST platform 200 utilizes one or more immutable ledgers 236 (e.g., one or more blockchains) to enable several content creators to access an ST registry service to mint ST tokens in a variety of forms including, but not limited to, physical ST tokens 242, complete ST token 244, bank ST token 246, and hybrid ST tokens 248.

The tokenizer is a component of the ST platform server 220 configured to provide a tokenization process that combines the NFT of the digital asset 214, the backing component 218, and a corresponding smart contract containing information and logic required for facilitating the creation, sale, modification, and exchange of the ST token. In addition to pairing the NFT and the backing component, the tokenizer 234 may combine one or more smart contracts generated by the smart contract mechanism 230.

In some embodiments, the output ST token 240 produced by the tokenizer 234 is a physical ST token 242. A physical ST token 242 is a type of NFT where the backing component 218 is a physical asset. In some embodiments, the physical asset is only redeemable if the owner of the physical ST token 242 opts to destroy their physical ST token 242. If the owner decides to destroy their physical ST token 242, the ST platform can take custody of the physical ST token 242 and destroy it. Upon destruction, the ST platform can facilitate the recovery of the physical asset from the vault 232 and provide that physical asset to the owner. Destruction of ST tokens can occur in a variety of ways. For instance, the ST platform 200 can assign the smart contract ownerAddress field to a null wallet address, or the ST platform 200 can enable an unchangeable method in the smart contract that makes the contract immutable/unchangeable.

In some embodiments, the output ST token 240 produced by the tokenizer 234 is a complete ST token 244. A complete ST token 244 is a type of NFT where the backing component 218 is both a physical asset and a banking mechanism. In some embodiments, the banking mechanism accrues a percentage of the sale price of the complete ST token 244. Funds allocated into the banking mechanism are stored and retrievable in multiple ways. For example, funds in the banking mechanism are stored via the corresponding smart contract holding the value of the funds in the contract. The funds may only be redeemed if conditions are satisfied as dictated in the smart contract. For example, one condition may be that funds are only redeemable if the complete ST token 244 is destroyed, as described above. The banking mechanism can also take the form of the vault 232, capable of storing the funds.

In some embodiments, the output ST token 240 produced by the tokenizer 234 is a bank ST token 246. A bank ST token 246 is a type of NFT where the backing component 218 is a banking mechanism. Similar to the complete ST token 244, in some embodiments, the banking mechanism accrues a percentage of the sale price of the bank ST token 246. Funds allocated into the banking mechanism are stored and retrievable in multiple ways. For example, funds in the banking mechanism are stored via the corresponding smart contract holding the value of the funds in the contract.

In some embodiments, the output ST token 240 produced by the tokenizer 234 is a hybrid ST token 248. A hybrid ST token 248 is a type of NFT where the backing component 218 and/or the underly NFT is modified or added upon. In some embodiments, the hybrid ST token 248 includes a physical asset and a banking mechanism as the backing component 218. A condition set forth in its smart contract can set forth guidance on how and when the owner of the hybrid ST token 248 can utilize funds in the banking mechanism to acquire additional physical assets that can be used as additional backing components 218. For example, once funds in the banking mechanism reach a certain threshold, the ST platform can utilize those funds to acquire an additional physical asset and associate that asset with the hybrid ST token 248. The additional physical asset can be stored in a similar fashion as the original physical asset.

In some embodiments, the hybrid ST token 248 includes a physical asset and a banking mechanism as the backing component 218. A condition set forth in its smart contract can set forth guidance on how and when the owner of the hybrid ST token 248 can utilize funds in the banking mechanism to procure an additional digital asset to append to the hybrid ST token 248. For example, once funds in the banking mechanism accrue to a certain threshold, the ST platform 200 can facilitate the procurement of an additional digital asset. In some embodiments, the additional digital asset is procured from a project organizer of the original digital asset 214 so as to allow both assets to relate to one another. Once the ST platform 200 receives the additional digital asset, the smart contract mechanism 230 can update the underlying smart contract, and the tokenizer 234 can combine the additional digital asset with the hybrid ST token 248.

In some embodiments, the ST platform 200 generates a child token out of the additional digital asset. In this instance, the smart contract mechanism 230 can update the smart contract of the hybrid ST token 248 such that it is assigned ownership of the child token. In some embodiments, instead of procuring an additional digital asset, the ST platform 200 procures an upgraded digital asset. For instance, the ST platform can facilitate procurement of the upgraded digital asset 1010 from the project organizer of the original digital asset 214.

As such, issuance of ST tokens, via the ST platform 200, enables verification of the authenticity of ST tokens independently of the content creator, or owner 204, by confirming that transactions written to one or more of the ledgers 236 are consistent with the smart contracts generated by the smart contract mechanism 230 associated with the ST tokens. Once the ST platform 200 receives the upgraded digital asset, the smart contract mechanism 230 can update the underlying smart contract, and the tokenizer 234 can change the original digital asset 218 to the upgraded digital asset 1010 in the hybrid ST token 248.

As shown, content creators, or owner 204, can provide the ST platform server 220 with a digital asset 214 and a backing component 218. The backing component 218 can include a physical asset and/or a bank mechanism that stores funds in escrow. The backing component 218 can be used to ensure a minimum value of the digital asset minted as an NFT.

In some embodiments, some or all of the ST Platform 200 logic, methods, and techniques, can also be executed on a platform smart contract. For example, the ST platform 200 operates as a server (e.g., as shown in FIG. 1) which interfaces with a platform smart contract to perform functionality. A platform smart contract is a computer program that is executed on a blockchain platform, specifically designed to handle the creation, ownership, and transfer of NFTs, and in this case, ST tokens. Examples of such functionality include, but are not limited to, minting a new ST Token, verifying Bank ST Token balances, facilitating trades between users, and the like. As such, at least a portion of the functionality described herein takes place on a blockchain, as opposed to a first party server, enabling further transparency for users.

It is noted that FIG. 2 is intended to depict the major representative components of an ST platform 200. In some embodiments, however, individual components may have greater or lesser complexity than as represented in FIG. 2, components other than or in addition to those shown in FIG. 2 may be present, and the number, type, and configuration of such components may vary.

### Example ST Token Creation and Utilization

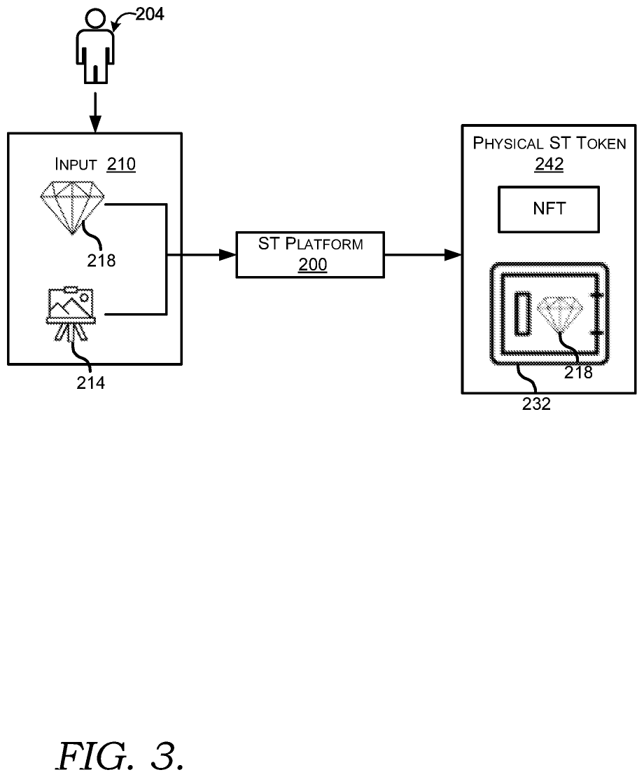

FIG. 3 is a block diagram illustrating an exemplary physical ST token 242 creation workflow, as described in FIG. 2. As shown, the input 210 includes a digital asset 214 and a backing component 218 in the form of a physical asset represented by a diamond icon. The owner 204 provides the input 210 to the ST platform 200 for the minting of a physical ST token 242. In some embodiments, a third-party (e.g., a project organizer providing a collection of NFTs) can provide the physical assets used as the backing components 218. The ST platform 200 can perform the techniques described above to convert the digital asset 214 into an NFT, store the backing component 218 in a vault 232, and tokenize a corresponding smart contract with the NFT to create the physical ST token 242.

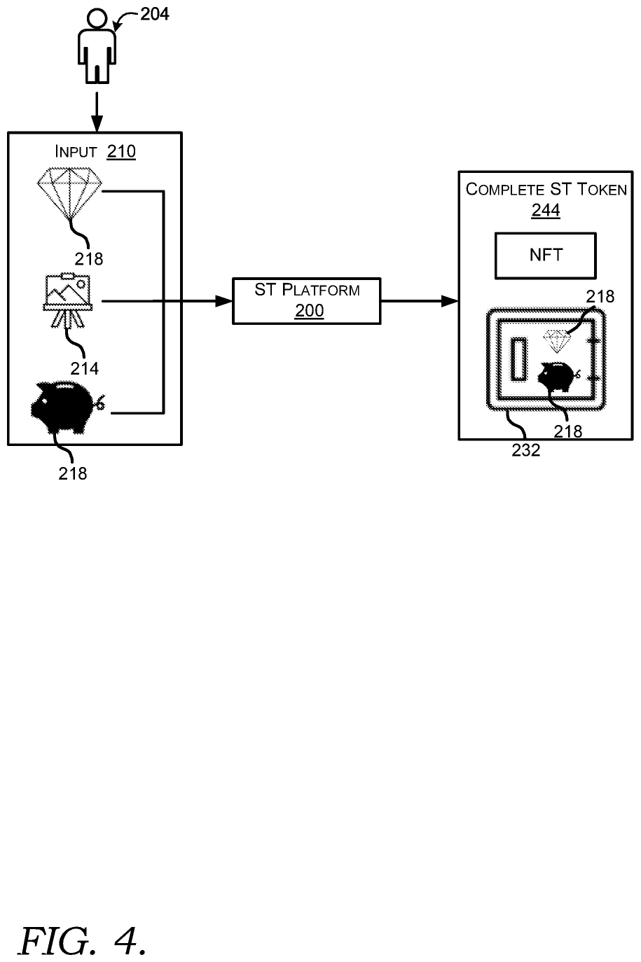

FIG. 4 is a block diagram illustrating an exemplary complete ST token 244 creation workflow, as described in FIG. 2. As shown, the input 210 includes a digital asset 214 and a backing component 218 in the form of a physical represented by a diamond icon, and a banking mechanism represented by a piggy bank icon. The owner 204 provides the input 210 to the ST platform 200 for minting a complete ST token 244. The ST platform 200 can perform the techniques described above to convert the digital asset 214 into an NFT and store the backing components 218 in a vault 232. In some embodiments, only the physical asset is stored in the vault 232, and the banking mechanism is stored by a smart contract associated with the complete ST token 244. The ST platform 200 can tokenize the NFT, at least a portion of the backing components 218, and the smart contract to create the complete ST token 244.

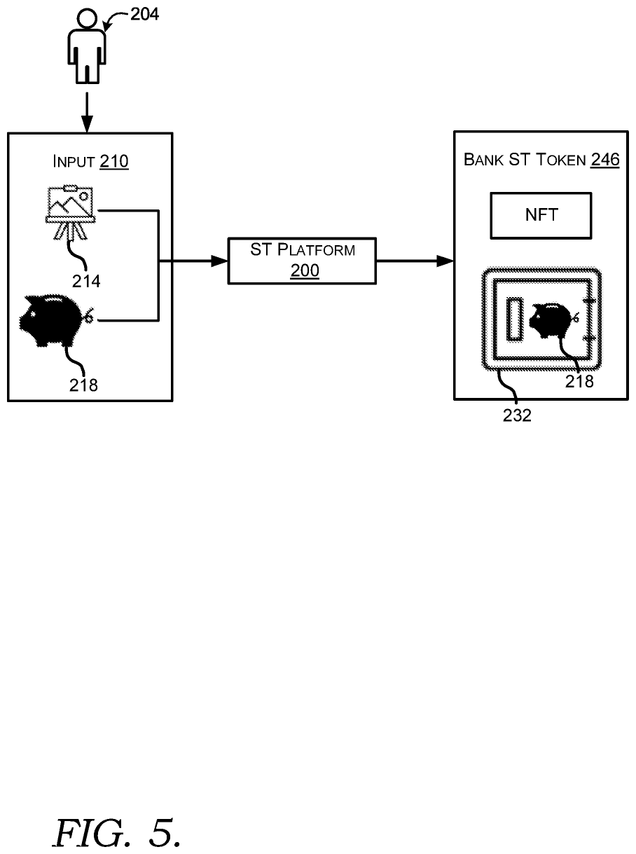

FIG. 5 is a block diagram illustrating an exemplary bank ST token 246 creation workflow, as described in FIG. 2. As shown, the input 210 includes a digital asset 214 and a backing component 218 in the form of a banking mechanism represented by a piggy bank icon. The owner 204 provides the input 210 to the ST platform 200 for minting a bank ST token 246. The ST platform 200 can perform the techniques described above to convert the digital asset 214 into an NFT and store the backing component 218 in a vault 232. In some embodiments, the banking mechanism is stored by a smart contract associated with the bank ST token 246. The ST platform 200 can tokenize the NFT, the backing component 218, and the smart contract to create the bank ST token 246.

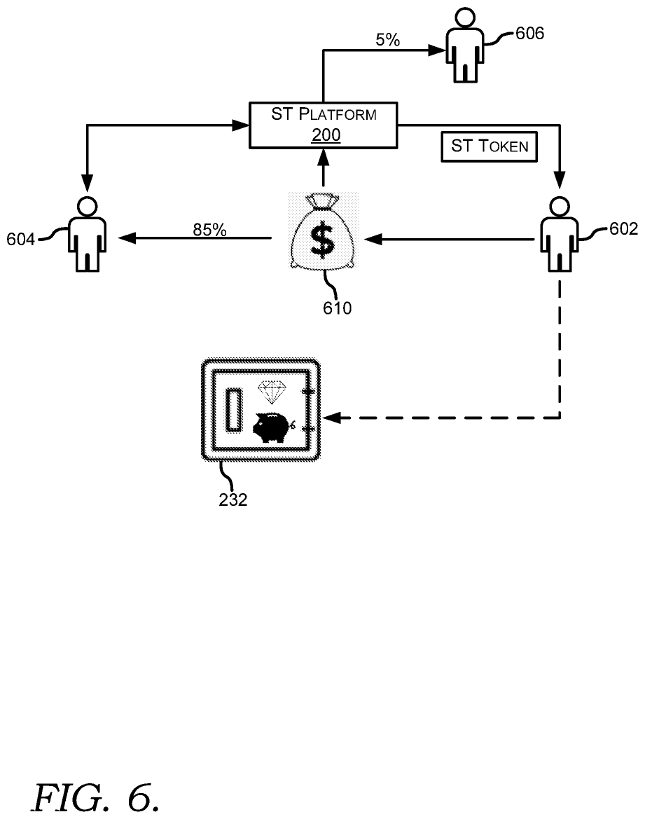

FIG. 6 is a block diagram illustrating an exemplary second-hand sale of a complete ST token 244 on the ST platform 200. A buyer 602 initiates a purchase of a complete ST token 244 from a seller 604 via a marketplace hosted by the ST platform 200. In this example, in order for the transaction to occur, the buyer 602 is required to deposit funds 610 to the banking mechanism associated with the complete ST token 244 as dictated by the smart contract. For instance, 10% of the total asking price is required to be deposited into the banking mechanism. This 10% can be in addition to the total asking price of the complete ST token 244.

Additionally, as shown in FIG. 6, 85% of the asking price is provided to the seller 604, 5% is provided to the artist 606 of the original digital asset associated with the complete ST token 244 as a royalty, and the remaining 10% is collected by the ST platform 200 as transaction fees. It should be noted, however, that these percentages are for illustration purposes only, and the percentages may vary. Additionally, the sale of other ST tokens (e.g., physical ST Tokens 242, bank ST tokens 246, hybrid ST tokens 248) can operate in a similar fashion as described in FIG. 6.

With every sale, the physical asset, if present, remains unaffected and remains stored in the vault 232, in an agreed-upon third-party facility, or potentially a first-party facility. Ownership of the physical token is registered in the ST platform 200 as well as on the ST token's smart contract until the current owner of the physical asset performs the steps required to recover the physical asset.

In some instances, the banking mechanism is not present such as with a physical ST token 242 being traded on the ST platform 200. As such, in an exemplary sale (similar to the sale of a complete ST token 244 shown in FIG. 3) of a physical ST token 242 on the ST platform 200, in place of the 10% fund of the sale price being deposited into the banking mechanism, the seller 604 can receive 85% of the payment from the buyer 602, the artist 606 can receive 10% of the funds as a royalty, and the ST platform 200 can receive 5% of the funds as a transaction fee.

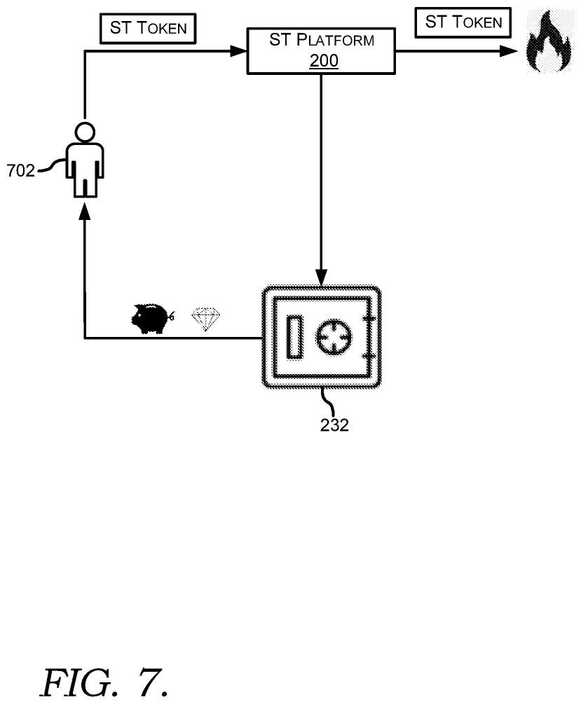

FIG. 7 is a block diagram illustrating an exemplary destruction of an ST token on the ST platform 200 workflow. Various embodiments of the present disclosure provide users with mechanisms on the ST platform 200 that allow owners of ST tokens to forego their ownership of the ST tokens and allow those owners to recover the backing component 218 assets associated with their ST tokens. In some embodiments, in order to recover the assets (e.g., funds in a banking mechanism, physical assets) used backing components, the owner of an ST token is required to provide the ST token to the ST platform 200 for destruction. The ST platform 200 can destroy, or “burn,” the ST token in exchange for the withdrawal of the backing component assets. As shown in FIG. 7, a complete ST token 244 on the ST platform 200 includes a banking mechanism and a physical asset. The funds accumulated in the banking mechanism as well as the physical asset, can be provided to the owner once the destruction of the ST token is performed.

The workflow, as shown, illustrates an owner of an ST token indicating to the ST platform that they wish to destroy their ST token and recover the assets associated with the backing component 218 of their ST token. It should be noted that this process can occur at any time or as stipulated in the ST token's smart contract. Upon destruction of the ST token, in this instance, a complete ST token 244, the ST platform 200 recovers the assets from the vault 232 and provides those assets to the owner 702.

Additionally, the sale of other ST tokens (e.g., physical ST Tokens 242, bank ST tokens 246, hybrid ST tokens 248) can operate in a similar fashion as described in FIG. 7. For example, in the instance of a physical ST token 242, where a banking mechanism is absent, only the corresponding physical asset is recovered and provided to the owner 702. In essence, the owner 702 has the right to forego digital ownership of their ST token in exchange for the assets backing the ST token.

### Exemplary Hybrid ST Token Utilization

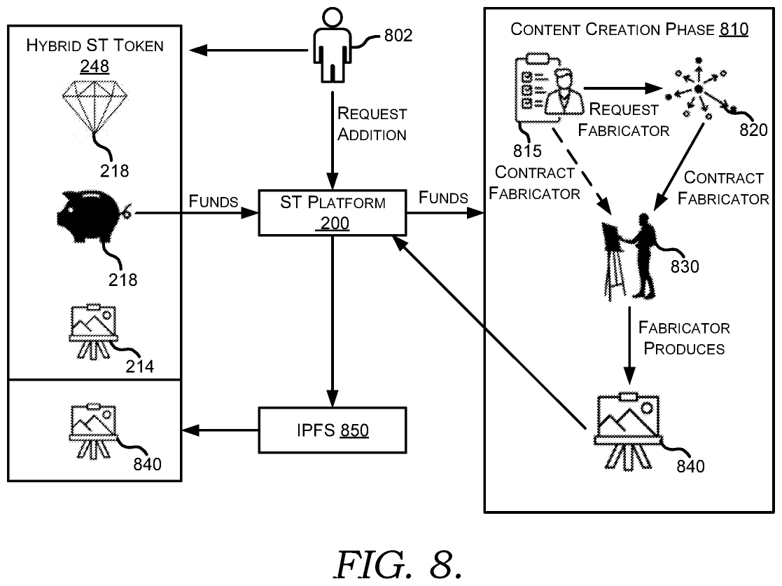

FIG. 8 is a block diagram illustrating a digital asset addition mechanism offered by a hybrid ST token 248 of the ST platform 200, in accordance with embodiments of the present disclosure. In some embodiments, the owner of a hybrid ST token 248 can request a change to their hybrid ST token 248 upon meeting a certain threshold as specified by its corresponding smart contract or project operator. The threshold can be set such that when the hybrid ST token's 248 banking mechanism accrues a certain amount of funds (e.g., $500, $1,000, $12,000, etc.), the threshold is met and the owner of the hybrid ST token 248 can request a digital asset addition.

For example, there is a collection of 1,000 NFTs representing animated avatars. Each of these NFTs is a variant of the ST token associated with the hybrid ST token 248. Each of these pieces may or may not be backed by a physical asset but include a banking mechanism. The banking mechanism requires that 5% of the proceeds of any sale of the hybrid ST token 248 be deposited in its respective banking mechanism. Within the hybrid ST token's 248 smart contract can include a threshold amount of funds in the banking mechanism to trigger the process of adding a digital asset to the hybrid ST token 248. For instance, $600 can be set.

Continuing with the example, the owner 802 owns one of the example NFTs. That particular NFT/hybrid ST token 248 has accrued $650 in its banking mechanism through the primary sale and any secondary sales. The owner 802 wishes to redeem/exchange the banking mechanism portion to add a digital asset to their hybrid ST token 248. In order to activate the request, the owner 802 makes a request with the ST platform 200 to facilitate the addition. Upon receiving the request, the ST platform 200 can check the corresponding smart contract and funds in the banking mechanism of the hybrid ST token 248. If insufficient funds are in the banking mechanism, then the request is denied by the ST platform 200. However, if the banking mechanism contains sufficient funds and meets the threshold, then the ST platform 200 withdraws the required funds from the banking mechanism.

In some embodiments, the ST platform 200 remits the withdrawn funds to a project organizer 815 and begins the content creation phase 810. Using those funds, the project organizer 815 can commission a digital asset fabrication. The commission can be performed by a decentralized autonomous organization 820 or produced by an internal fabricator 830. Upon completion, an additional digital asset 840 is created. It should be noted that the content creation phase 810 is for illustrative purposes only. Other known means of procuring additional digital assets may be used without deviating from the scope of the present disclosure.

Upon creation of the additional digital asset, the project organizer 815 can transmit the digital asset to the ST platform 200. Upon receiving the additional digital asset 840, the ST platform 200 can update the hybrid ST token's 248 smart contract to include the additional digital asset. In some embodiments, the ST platform 200 creates a new smart contract and NFT out of the additional digital asset 840 and mints a new ST token. Upon creation, the ST platform 200 can assign ownership of the new ST token to the hybrid ST Token's 248 smart contract.

Additionally, the ST platform 200 can utilize an InterPlanetary File System (IPFS) 850 to store and share the additional digital asset. IPFS 850 is a protocol and network designed to create a peer-to-peer method of storing and sharing hypermedia in a distributed file system. In regard to ST tokens, or NFTs, IPFS 850 can be used as a decentralized storage solution for the media files (e.g., digital asset 214) associated with the ST tokens. In other words, instead of relying on a centralized server or ST platform 200 to store and serve the media files, they can be stored on the IPFS 850 network, which provides a more secure and resilient solution, as well as greater accessibility and control for creators and owners of the ST tokens.

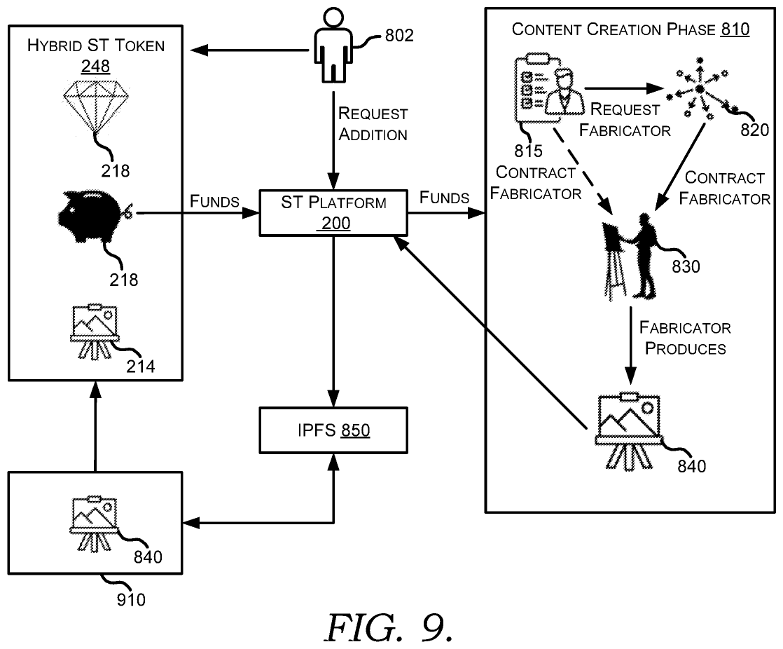

Referring now to FIG. 9, FIG. 9 is a block diagram illustrating a digital asset addition mechanism offered by a hybrid ST token 248 of the ST platform 200, in accordance with embodiments of the present disclosure. In this instance, the digital asset addition works in a similar fashion as described in FIG. 8. However, once procurement of the additional digital asset 840 is completed, the ST platform 200 creates a child ST token 910 and assigns a new backing component 218 (e.g., physical asset and/or banking mechanism) to the child ST token 910.

Upon creation of the child ST token 910, the ST platform 200 uploads the additional digital asset 840 to the IPFS 850, allowing the additional digital asset 840 to be represented by an IPFS network link. Additionally, the ST platform modifies the original hybrid ST token's 248 smart contract to show ownership of the child ST token 910. In some embodiments, the smart contract of the parent hybrid ST token 248 is further modified with an option that provides functionality to transfer and sell the child ST token 910.

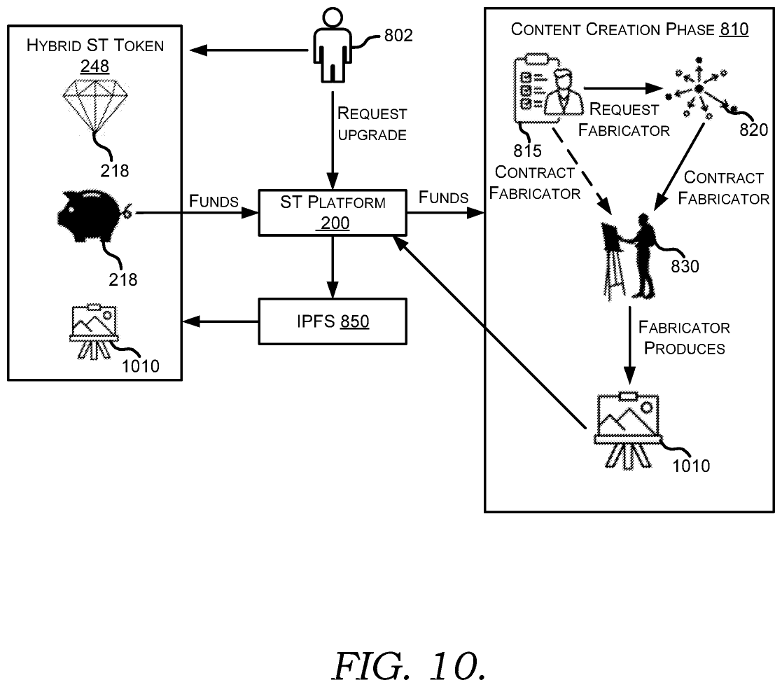

FIG. 10 is a block diagram illustrating a digital asset upgrade mechanism offered by a hybrid ST token 248 of the ST platform 200, in accordance with embodiments of the present disclosure. In some embodiments, the owner 802 of a hybrid ST token 248 can request an upgrade to their digital asset associated with their hybrid ST token 248 upon meeting a certain threshold as specified by its corresponding smart contract or project operator. The threshold can be set such that when the hybrid ST token's 248 banking mechanism accrues a certain amount of funds (e.g., $500, $1,000, $12,000, etc.), the threshold is met and the owner of the hybrid ST token 248 can request a digital asset upgrade.

In this particular example, the hybrid ST token 248 has accrued enough funds in its banking mechanism through the primary sale and any secondary sales of the hybrid ST token 248. The owner 802 wishes to redeem/exchange the banking mechanism portion to upgrade the digital asset of their hybrid ST token 248. In order to activate the request, the owner 802 makes a request with the ST platform 200 to facilitate the upgrade. Upon receiving the request, the ST platform 200 can check the corresponding smart contract and funds in the banking mechanism of the hybrid ST token 248. If insufficient funds are in the banking mechanism, then the request is denied by the ST platform 200. However, if the banking mechanism contains sufficient funds and meets the threshold, then the ST platform 200 withdraws the required funds from the banking mechanism.

In some embodiments, the ST platform 200 remits the withdrawn funds to a project organizer 815 and begins the content creation phase 810. Using those funds, the project organizer 815 can commission a digital asset fabrication. The commission can be performed by a decentralized autonomous organization 820 or produced by an internal fabricator 830. Upon completion, an upgraded digital asset 1010 is created. It should be noted that the content creation phase 810 is for illustrative purposes only. Other known means of procuring additional digital assets may be used without deviating from the scope of the present disclosure.

Upon creation of the upgraded digital asset, the project organizer 815 can transmit the digital asset to the ST platform 200. Upon receiving the additional digital asset 840, the ST platform 200 can update the hybrid ST token's 248 smart contract to include the upgraded digital asset 1010 and remove the original digital asset 214. Additionally, the ST platform 200 can utilize an IPFS 850 to store and share the upgraded digital asset.

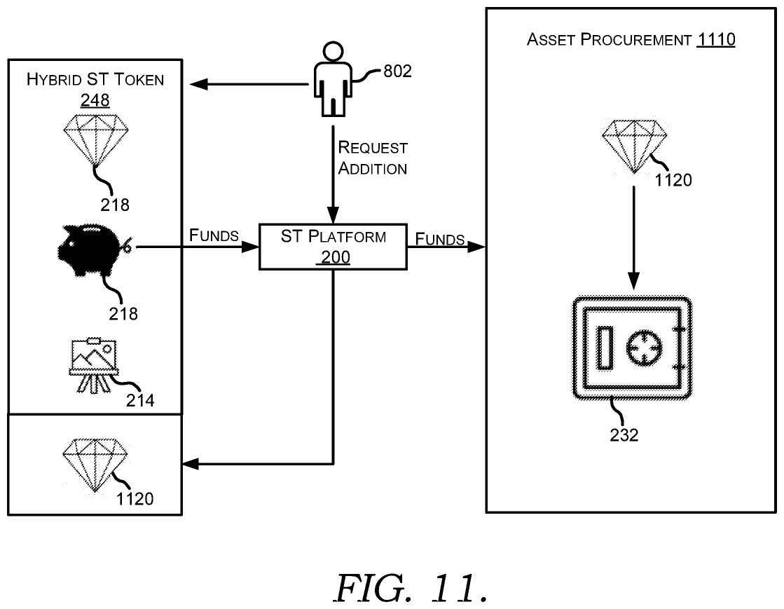

FIG. 11 is a block diagram illustrating a physical asset addition mechanism offered by a hybrid ST token 248 on the ST platform 200, in accordance with embodiments of the present disclosure. In some embodiments, the owner 802 of a hybrid ST token 248 can request an addition to their physical asset (backing component 218) associated with their hybrid ST token 248 upon meeting a certain funds threshold as specified by its corresponding smart contract or project operator. The threshold can be set such that when the hybrid ST token's 248 banking mechanism accrues a certain amount of funds (e.g., $500, $1,000, $12,000, etc.), the threshold is met and the owner of the hybrid ST token 248 can request a physical asset addition.

In this particular example, the hybrid ST token 248 has accrued enough funds in its banking mechanism through the primary sale and any secondary sales of the hybrid ST token 248. The owner 802 wishes to redeem/exchange a portion of the funds stored by the banking mechanism to purchase an additional physical asset for their hybrid ST token 248. In order to activate the request, the owner 802 makes a request with the ST platform 200 to facilitate the addition. Upon receiving the request, the ST platform 200 can check the corresponding smart contract and funds in the banking mechanism of the hybrid ST token 248. If insufficient funds are in the banking mechanism, then the request is denied by the ST platform 200. However, if the banking mechanism contains sufficient funds and meets the threshold, then the ST platform 200 withdraws the portion of required funds from the banking mechanism.

Using those funds, the ST platform 200 can facilitate the purchase and procurement 1110 of an additional physical asset 1120. In some embodiments, the ST platform can remit the purchase and procurement of the additional physical asset 1120 to an agreed-upon third party. Upon procurement, the ST platform 200 can store the additional physical asset 1120 in the vault 232. Additionally, the ST platform 200 can also update the smart contract associated with the hybrid ST token 248 to associate the additional physical asset 1120 with the hybrid ST token 248.

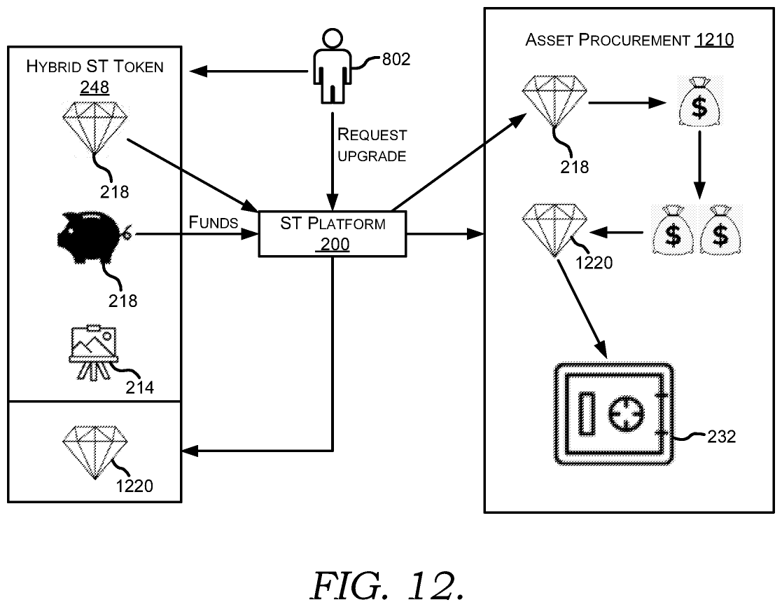

FIG. 12 is a block diagram illustrating a physical asset upgrade mechanism offered by a hybrid ST token 248 on the ST platform 200, in accordance with embodiments of the present disclosure. In some embodiments, the owner 802 of a hybrid ST token 248 can request an upgrade to their physical asset 218 associated with their hybrid ST token 248 upon meeting a certain funds threshold as specified by its corresponding smart contract or project operator. The threshold can be set such that when the hybrid ST token's 248 banking mechanism accrues a certain amount of funds (e.g., $500, $1,000, $12,000, etc.), the threshold is met and the owner of the hybrid ST token 248 can request a physical asset addition.

In this particular example, the hybrid ST token 248 has accrued enough funds in its banking mechanism through the primary sale and any secondary sales of the hybrid ST token 248. The owner 802 wishes to redeem/exchange a portion of the funds stored by the banking mechanism to purchase an upgraded physical asset for their hybrid ST token 248. In order to activate the request, the owner 802 makes a request with the ST platform 200 to facilitate the addition. Upon receiving the request, the ST platform 200 can check the corresponding smart contract and funds in the banking mechanism of the hybrid ST token 248. If insufficient funds are in the banking mechanism, then the request is denied by the ST platform 200. However, if the banking mechanism contains sufficient funds and meets the threshold, then the ST platform 200 withdraws the portion of required funds from the banking mechanism. Additionally, the ST platform recovers the physical asset from its stored location (e.g., the vault 232).

During asset procurement 1210, the ST platform 200 can facilitate the sale of the original physical asset. The sale can be performed directly by the ST platform 200 or performed by an agreed-upon third party. Using those funds and the fund withdrawn from the banking mechanism, the ST platform 200 can facilitate the purchase and procurement of an upgraded physical asset 1220. In some embodiments, the ST platform can remit the purchase and procurement of the upgraded physical asset 1220 to an agreed-upon third party. Upon procurement, the ST platform 200 can store the upgraded physical asset 1220 in the vault 232. Additionally, the ST platform 200 can also update the smart contract associated with the hybrid ST token 248 to associate the upgraded physical asset 1220 with the hybrid ST token 248.

### Example Hybrid ST Token Configurations

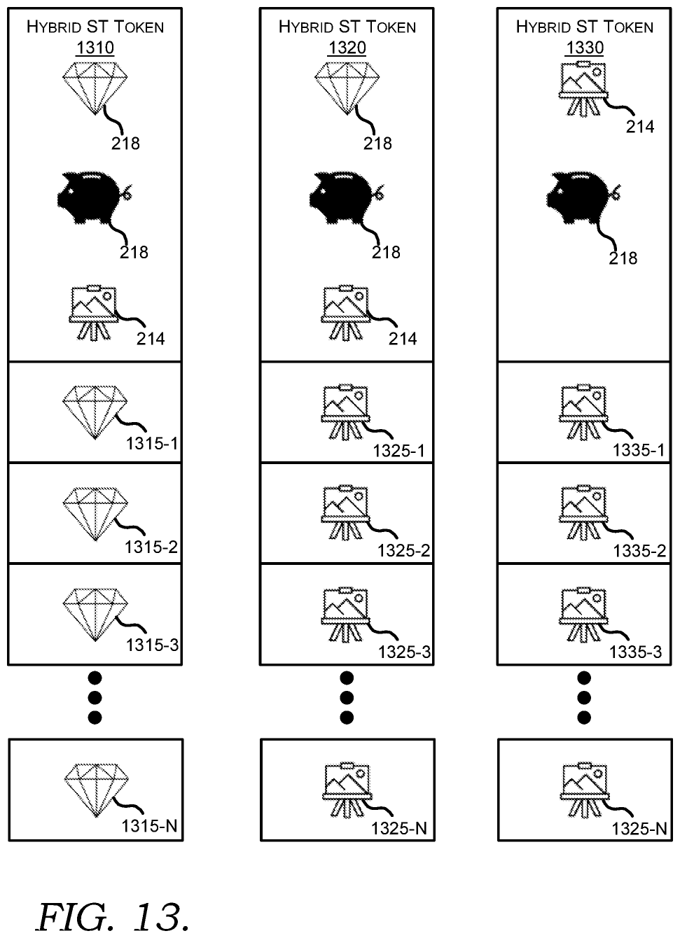

FIGS. 13-15 are block diagrams illustrating various configurations of a hybrid ST token 248, in accordance with embodiments of the present disclosure. As shown in FIG. 13, a hybrid ST token 1310 (similar to hybrid ST token 248 of FIG. 2) includes a backing components 218 configuration that includes a physical asset and a banking mechanism. Additionally, the hybrid ST token 1310 has additional physical assets 1315-1, 1315-2, 1315-3, 1315-N, (collectively “additional physical assets 1315”) where N is a variable integer representing any number of possible additional physical assets 1315. In this configuration, the smart contract of the parent hybrid ST token 1310 is amended to reference the additional physical asset 1315-1. Subsequent additional physical assets 1315 are referenced in the smart contracts of the preceding additional physical assets 1315. For example, the additional physical asset 1315-3 is referenced in the smart contract of the additional physical asset 1315-2, and so on.

As also shown in FIG. 13, a hybrid ST token 1320 (similar to hybrid ST token 248 of FIG. 2) includes backing components 218 configured to include a physical asset and a banking mechanism. Additionally, the hybrid ST token 1310 has additional digital assets 1325-1, 1325-2, 1325-3, 1325-N, (collectively “additional digital assets 1325”) where N is a variable integer representing any number of possible additional digital assets 1325. In this configuration, the smart contract of the parent hybrid ST token 1320 is amended to reference the additional digital asset 1325-1. Subsequent additional digital assets 1325 are referenced in the smart contracts of the preceding additional digital assets 1325. For example, the additional digital asset 1325-2 is referenced in the smart contract of the additional digital asset 1325-1, and so on.

As further shown in FIG. 13, a hybrid ST token 1330 (similar to hybrid ST token 248 of FIG. 2) includes a backing component 218 configured to include a banking mechanism. Additionally, the hybrid ST token 1310 has additional digital assets 1335-1, 1335-2, 1335-3, 1335-N, (collectively “additional digital assets 1335”), where N is a variable integer representing any number of possible additional digital assets 1335. In this configuration, the smart contract of the parent hybrid ST token 1330 is amended to reference the additional digital asset 1335-1. Subsequent additional digital assets 1335 are referenced in the smart contracts of the preceding additional digital assets 1335. For example, the additional digital asset 1335-3 is referenced in the smart contract of the additional digital asset 1335-2, and so on.

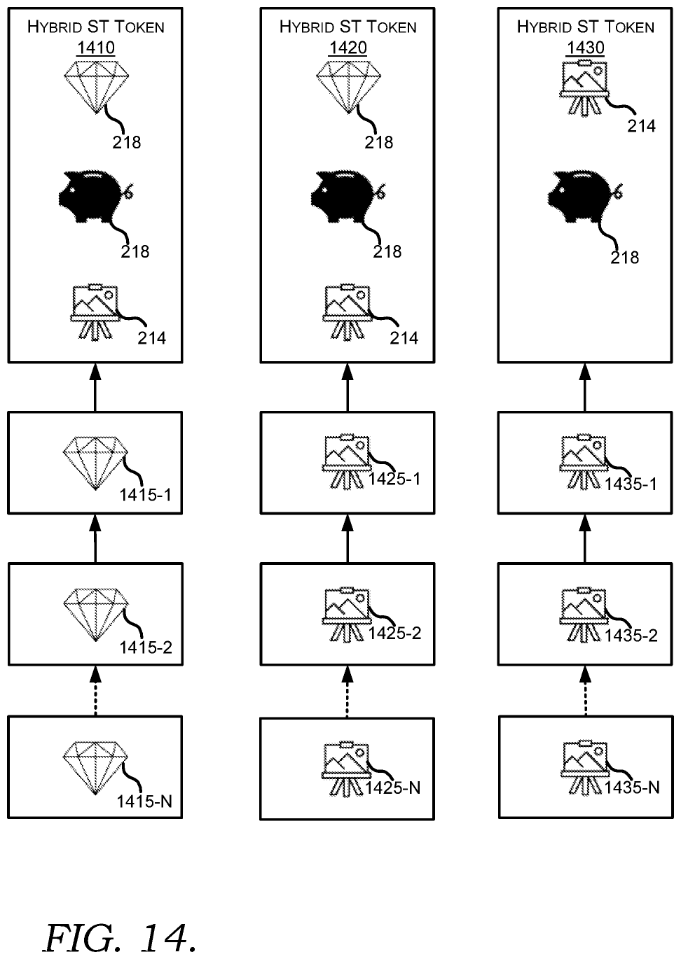

As shown in FIG. 14, a hybrid ST token 1410 (similar to hybrid ST token 248 of FIG. 2) includes backing components 218 configured to include a physical asset and a banking mechanism. Additionally, the hybrid ST token 1410 has additional physical assets 1415-1, 1415-2, 1415-N, (collectively “additional physical assets 1415”), where N is a variable integer representing any number of possible additional physical assets 1415. In this configuration, the ST platform 200 converts the additional physical assets 1415 into child tokens (with their own smart contracts and potentially their own backing components). In some embodiments, the child tokens can be minted and tokenized into ST tokens. Each child token can also be referenced by the preceding child token and connected like a linked list. The smart contract of the parent hybrid ST token 1410 is amended to reference the child token of the additional physical asset 1415-1.

As also shown in FIG. 14, a hybrid ST token 1420 (similar to hybrid ST token 248 of FIG. 2) includes backing components 218 configured to include a physical asset and a banking mechanism. Additionally, the hybrid ST token 1420 has additional digital assets 1425-1, 1425-2, 1425-N (collectively “additional digital assets 1425”), where N is a variable integer representing any number of possible additional digital assets 1425. In this configuration, the ST platform 200 converts the additional digital assets 1425 into child tokens (with their own smart contracts and potentially their own backing components). Each child token is referenced by the preceding child token and connected like a linked list. The smart contract of the parent hybrid ST token 1420 is amended to reference the child token of the additional digital asset 1425-1.

As further shown in FIG. 14, a hybrid ST token 1430 (similar to hybrid ST token 248 of FIG. 2) includes backing components 218 configured to include a banking mechanism. Additionally, the hybrid ST token 1420 has additional digital assets 1435-1, 1435-2, 1435-N (collectively “additional digital assets 1435”), where N is a variable integer representing any number of possible additional digital assets 1435. In this configuration, the ST platform 200 converts the additional digital assets 1435 into child tokens (with their own smart contracts and potentially their own backing components). Each child token is referenced by the preceding child token and connected like a linked list. The smart contract of the parent hybrid ST token 1430 is amended to reference the child token of the additional digital asset 1435-1.

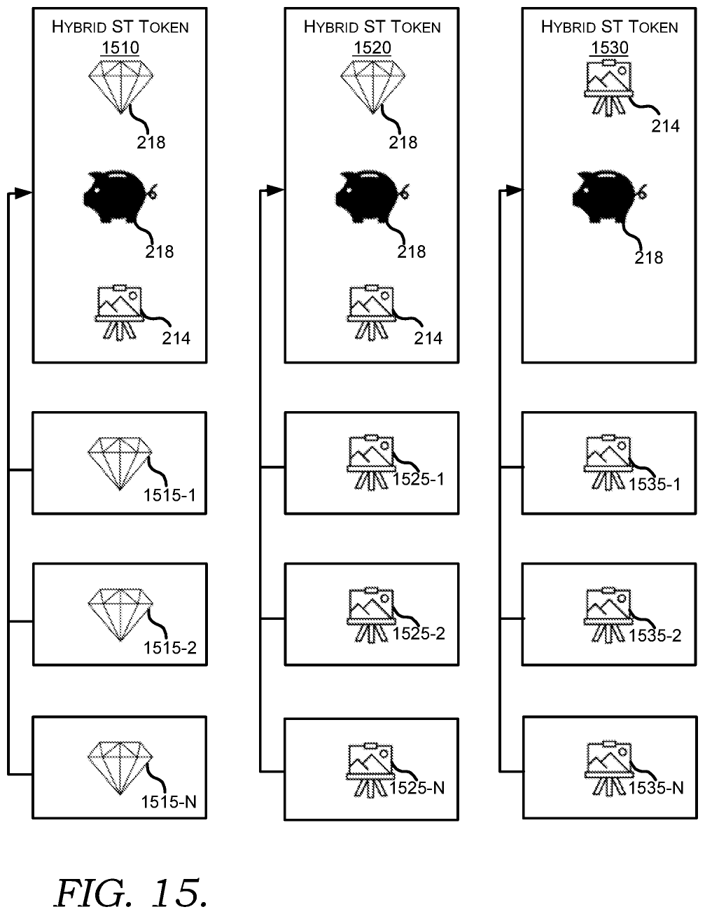

As shown in FIG. 15, a hybrid ST token 1510 (similar to hybrid ST token 248 of FIG. 2) includes backing components 218 configured to include a physical asset and a banking mechanism. Additionally, the hybrid ST token 1510 has additional physical assets 1515-1, 1515-2, 1515-N (collectively “additional physical assets 1515”), where N is a variable integer representing any number of possible additional physical assets 1515. In this configuration, the ST platform 200 converts the additional physical assets 1515 into child tokens (with their own smart contracts and potentially their own backing components). Each child token is referenced by the preceding child token and connected like a linked list. Additionally, the smart contract of the parent hybrid ST token 1510 is amended to reference all child tokens of the additional physical assets 1515.

As also shown in FIG. 15, a hybrid ST token 1520 (similar to hybrid ST token 248 of FIG. 2) includes backing components 218 configured to include a physical asset and a banking mechanism. Additionally, the hybrid ST token 1520 has additional digital assets 1525-1, 1525-2, 1525-N (collectively “additional digital assets 1525”), where N is a variable integer representing any number of possible additional digital assets 1525. In this configuration, the ST platform 200 converts the additional digital assets 1525 into child tokens (with their own smart contracts and potentially their own backing components). Each child token is referenced by the preceding child token and connected like a linked list. Additionally, the smart contract of the parent hybrid ST token 1520 is amended to reference all child tokens of the additional digital assets 1525.

As further shown in FIG. 15, a hybrid ST token 1530 (similar to hybrid ST token 248 of FIG. 2) includes backing components 218 configured to include a banking mechanism. Additionally, the hybrid ST token 1520 has additional digital assets 1535-1, 1535-2, 1535-N (collectively “additional digital assets 1535”), where N is a variable integer representing any number of possible additional digital assets 1535. In this configuration, the ST platform 200 converts the additional digital assets 1535 into child tokens (with their own smart contracts and potentially their own backing components). Each child token is referenced by the preceding child token and connected like a linked list. Additionally, the smart contract of the parent hybrid ST token 1530 is amended to reference all child tokens of the additional digital assets 1535.

### Example Flow Diagrams

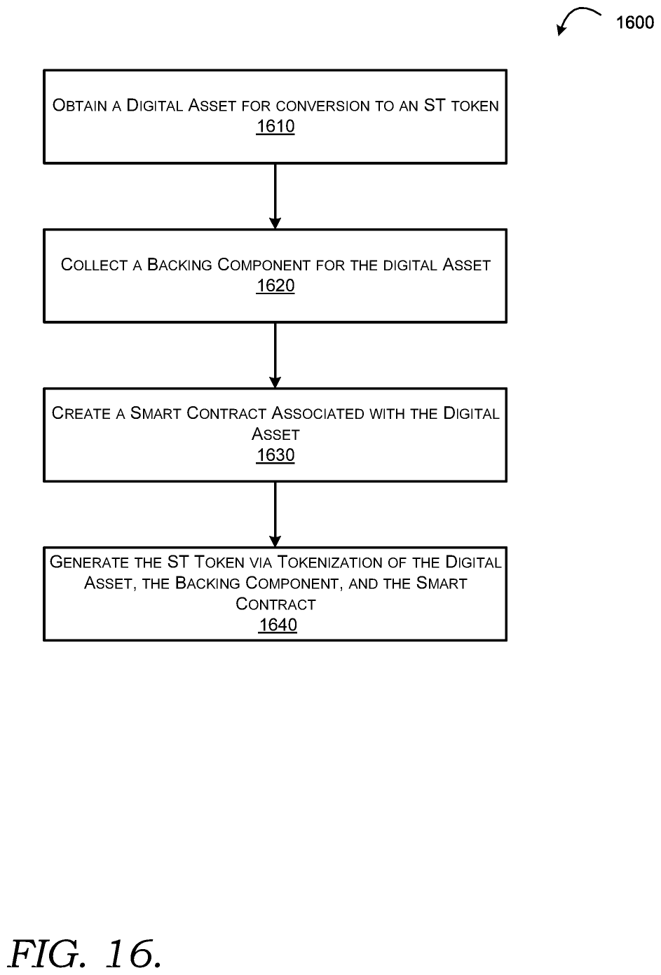

With reference now to FIGS. 16-18, flow diagrams are provided illustrating various methods. Each block of the methods 1600-1800 and any other methods described herein comprise a computing process performed using any combination of hardware, firmware, and/or software. For instance, in some embodiments, various functions are carried out by a processor executing instructions stored in memory. In some cases, the methods are embodied as computer-usable instructions stored on computer storage media. In some implementations, the methods are provided by a standalone application, a service or hosted service (standalone or in combination with another hosted service), or a plug-in to another product, to name a few.

FIG. 16 illustrates a flowchart 1600 of a series of acts in a method of creating an ST token from a digital asset and backing component provided by a user to an ST platform, in accordance with embodiments of the present disclosure. In one or more embodiments, the method 1600 is performed in a digital medium environment that includes the ST platform 200. The method 1600 is intended to be illustrative of one or more methods in accordance with the present disclosure and is not intended to limit potential embodiments. Alternative embodiments can include additional, fewer, or different steps than those articulated in FIG. 16.

The method 1600 includes a step 1610 of obtaining a digital asset for conversion to an ST token. Digital assets include, but are not limited to, cryptocurrencies, digital tokens, digital art, domain names, software, and digital media. In some embodiments, the digital asset is a digital artwork provided by a project organizer releasing a limited collection of pieces of art.

The method 1600 also includes collecting a backing component for the digital asset. This is illustrated at step 1620. The backing component can be either a physical asset or a banking mechanism, or both. A physical asset can be any tangible item that has an inherent value and can be used or consumed to generate income or serve a particular purpose. For example, physical assets include real estate, commodities (e.g., oil, natural gas, precious gems), collectibles, machinery, precious metals (e.g., gold, silver, platinum, etc.), and inventory. The banking mechanism is configured to provide a digital container for storing funds that are held in escrow by the ST platform, or other third-party entity.

The method 1600 further includes creating a smart contract associated with the digital asset and the backing component. This is illustrated at step 1630. A smart contract can be a self-executing program or code that is stored on a blockchain and automatically enforces the terms of an agreement between parties. The terms of the agreement can also include the requirements for accessing the backing component as well as accruing funds into the backing component (e.g., the banking mechanism). The terms of the agreement can also include threshold requirements for modifications performed to the ST token (e.g., hybrid ST tokens). For example, the smart contract can include terms that set a threshold for funds accrued in the banking mechanism that must be met before and addition or upgrade can be performed on the ST token.

The method 1600 also includes generating the ST token via tokenization of the digital asset, the backing component (e.g., the physical asset and/or banking mechanism), and the smart contract. This is illustrated at step 1640. Depending on the configuration, the ST token can be a physical ST token, a complete ST token, a bank ST token, or a hybrid ST token. In instances where the backing component of the ST token includes a physical asset, that asset can either be stored in a vault managed and operated by the ST platform or by an agreed-upon third party.

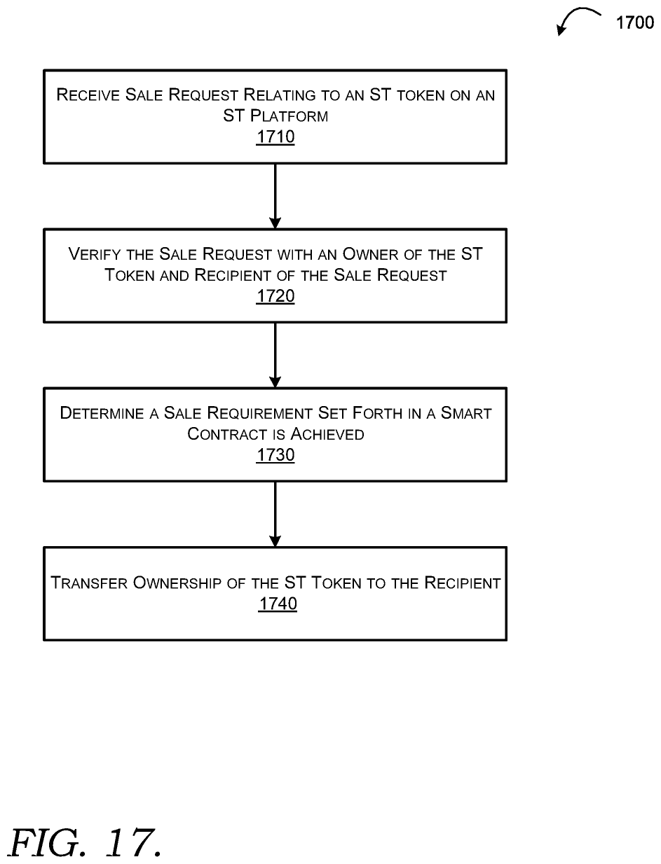

FIG. 17 illustrates a flowchart 1700 of a series of acts in a method of facilitating a sale of an ST token between a buyer and a seller operating within an ST platform, in accordance with embodiments of the present disclosure. In one or more embodiments, the method 1700 is performed in a digital medium environment that includes the ST platform 200. The method 1700 is intended to be illustrative of one or more methods in accordance with the present disclosure and is not intended to limit potential embodiments. Alternative embodiments can include additional, fewer, or different steps than those articulated in FIG. 17.

The method 1700 includes receiving a sale request relating to an ST token managed by an ST platform. This is illustrated at step 1710. The sale request can include information such as the sale price, the parties involved, any additional requirements set forth by a smart contract of the ST token, as well as any other information that may be pertinent to the sale of the ST token.

The method 1700 also includes verifying the sale request with an owner of the ST token to verify that the sale is legitimate. This is illustrated at step 1720. Additionally, the ST platform 200 can also verify the sale request with the buyer of the ST token to ensure that they wish to proceed with the purchase and to also ensure that they have the necessary funds to proceed.

The method 1700 further includes determining a sale requirement set forth in a smart contract associated with the ST token is achieved and/or met. For example, a sale requirement may dictate a time window when the ST token may be sold, a minimum amount of funds required to purchase the ST token, as well as various sale percentages that are required to be distributed to the banking mechanism, artist, ST platform, and the like. Upon determining the sale requirements are met, the ST platform can transfer at least a portion of the agreed-upon funds relating to the sale to the owner. This is illustrated at step 1730. For instance, if the smart contract dictates that the owner receives 80% of the sale price, then the ST platform can transfer 80% of the sale price to the owner.

The method 1700 further includes transferring ownership of the ST token to the recipient, or buyer, of the ST token. This is illustrated at step 1740. The transfer can include updating the smart contract with the new owner's information as well as updating a ledger on the blockchain with the owner's information. Additionally, if the ST token includes a physical asset stored in a vault or other secure location, the new owner may request a transfer of location on a new agreed-upon secure location.

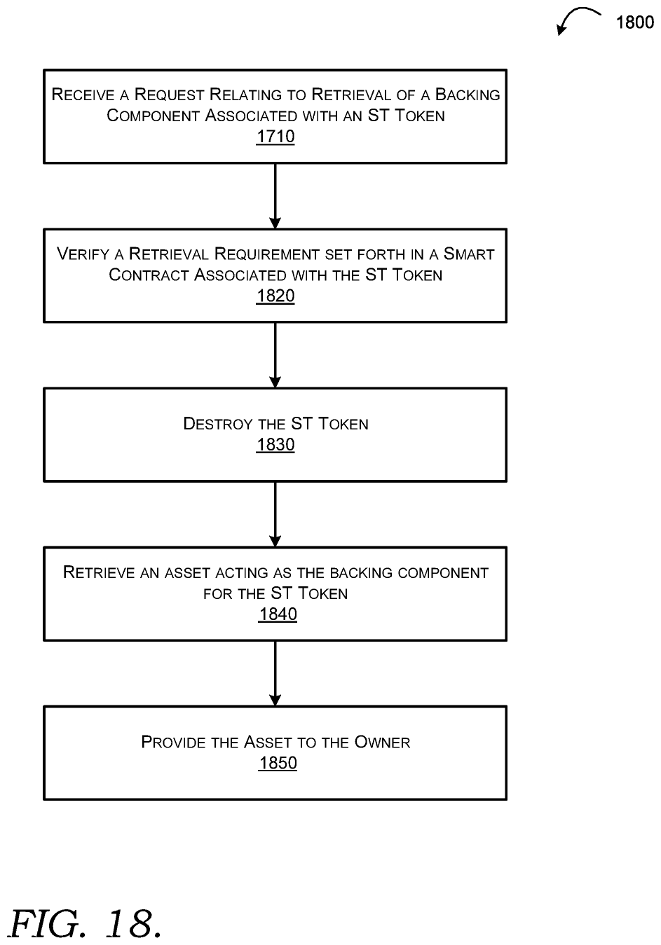

FIG. 18 illustrates a flowchart 1800 of a series of acts in a method of facilitating a retrieval of backing components of an ST token by destroying the ST token, in accordance with embodiments of the present disclosure. In one or more embodiments, the method 1800 is performed in a digital medium environment that includes the ST platform 200. The method 1800 is intended to be illustrative of one or more methods in accordance with the present disclosure and is not intended to limit potential embodiments. Alternative embodiments can include additional, fewer, or different steps than those articulated in FIG. 18.

The method 1800 includes receiving a request relating to an ST token managed by an ST platform to retrieve a backing component associated with the ST. This is illustrated at step 1810. The request can include information indicating requirements set forth by a smart contract of the ST token have been, as well as any other information that may be pertinent to the retrieval of the backing component of the ST token.

The method 1800 includes verifying a retrieval requirement set forth in the smart contract associated with the ST token is achieved. This is illustrated at step 1820. The information collected in the request can be checked and verified to ensure that all requirements are met.

Upon verifying the retrieval requirement, the ST platform destroys the ST token as part of the retrieval requirements. This is illustrated at step 1830. A part of the retrieval requirement a user is required to burn their ST token in order to redeem the backing component associated with the ST token. Destroying, or burning, refers to the act of permanently and irreversibly destroying the ST token by sending it to an address that is not retrievable. Burning the ST token can also be performed by assigning the ownerAddress stored in the ST's smart contract to a ‘null’ wallet address. In another example, burning an ST token can be performed by enabling an unchangeable method in the ST's smart contract making the contract immutable and unchangeable.

The method 1800 also includes retrieving an asset acting at the backing component for the ST token. This is illustrated at step 1840. The asset associated with the backing component, as explained, can be a physical asset stored in a vault or funds stored in a banking mechanism. Retrieval of the asset can include retrieval of the physical asset, any funds stored in the banking mechanism, or both. Once retrieved, the ST platform 200 can provide the asset, or assets, to the owner. This is illustrated at step 1850.

### Example Computing Environment

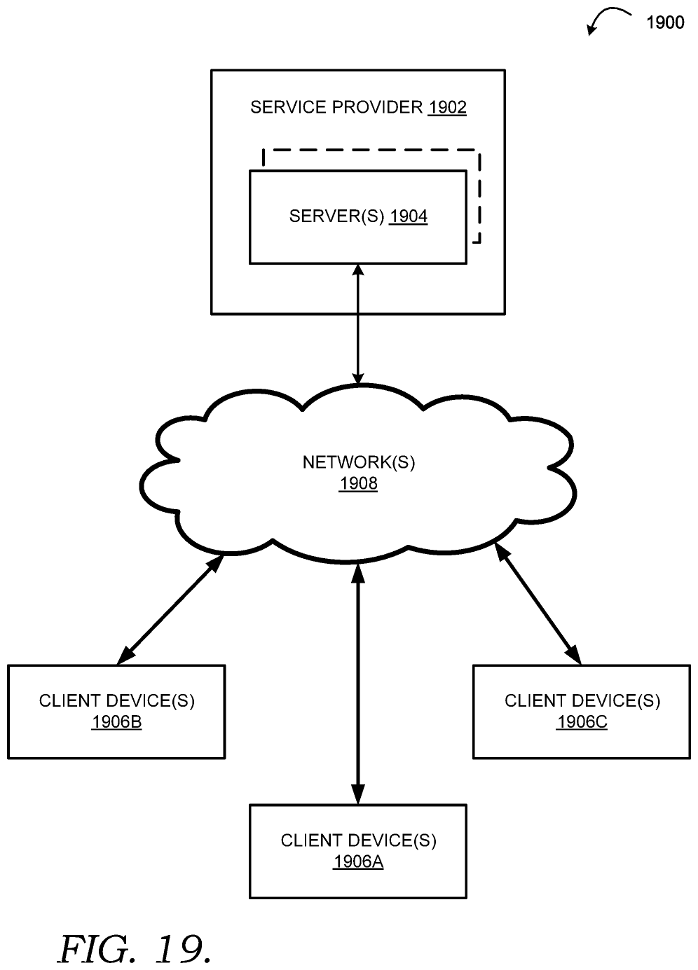

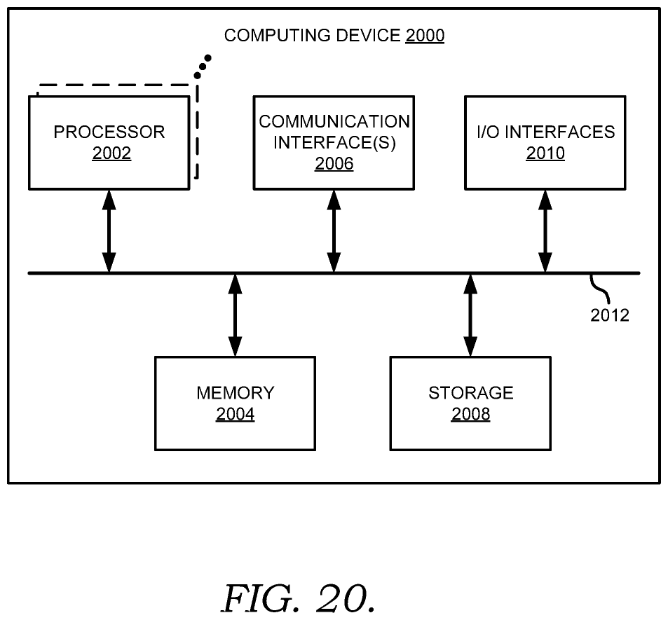

FIG. 19 illustrates a schematic diagram of an exemplary computing environment 1900 in which the ST platform 200 can operate in accordance with one or more embodiments of the present disclosure. In one or more embodiments, the computing environment 1900 includes a service provider 1902 which may include one or more servers 1904 connected to a plurality of client devices 1906A-1906C via one or more networks 1908. The client devices 1906A-1906C, the one or more networks 1908, the service provider 1902, and the one or more servers 1904 may communicate with each other or other components using any communication platforms and technologies suitable for transporting data and/or communication signals, including any known communication technologies, devices, media, and protocols supportive of remote data communications, examples of which will be described in more detail below with respect to FIG. 20.

Although FIG. 19 illustrates a particular arrangement of the client devices 1906A-1906C, the one or more networks 1908, the service provider 1902, and the one or more servers 1904, various additional arrangements are possible. For example, the client devices 1906A-1906C may directly communicate with the one or more servers 1904, bypassing the network 1908. Or alternatively, the client devices 1906A-1906C may directly communicate with each other. The service provider 1902 may be a public cloud service provider which owns and operates its own infrastructure in one or more data centers and provides this infrastructure to customers and end users on demand to host applications on the one or more servers 1904. The servers may include one or more hardware servers (e.g., hosts), each with its own computing resources (e.g., processors, memory, disk space, networking bandwidth, etc.), which may be securely divided between multiple customers, each of which hosts their own applications on the one or more servers.

In some embodiments, the service provider may be a private cloud provider who maintains cloud infrastructure for a single organization. The one or more servers 1904 may similarly include one or more hardware servers, each with its own computing resources, which are divided among applications hosted by the one or more servers for use by members of the organization or their customers.

Similarly, although the computing environment 1900 of FIG. 19 is depicted as having various components, the computing environment 1900 may have additional or alternative components. For example, the environment 1900 can be implemented on a single computing device with the ST platform 200. In particular, ST platform 200 may be implemented in whole or in part on the client device 1902A.

As illustrated in FIG. 19, the environment 1900 may include client devices 1906A-1906C. The client devices 1906A-1906C may comprise any computing device. For example, client devices 1906A-1906C may comprise one or more personal computers, laptop computers, mobile devices, mobile phones, tablets, special purpose computers, TVs, or other computing devices, including computing devices described below with regard to FIG. 19. Although three client devices are shown in FIG. 19, it will be appreciated that client devices 1906A-1906C may comprise any number of client devices (greater or smaller than shown).

Moreover, as illustrated in FIG. 19, the client devices 1906A-1906C and the one or more servers 1904 may communicate via one or more networks 1908. The one or more networks 1908 may represent a single network or a collection of networks (such as the Internet, a corporate Intranet, a virtual private network (VPN), a local area network (LAN), a wireless local network (WLAN), a cellular network, a wide area network (WAN), a metropolitan area network (MAN), or a combination of two or more such networks. Thus, the one or more networks 1908 may be any suitable network over which the client devices 1906A-1906N may access service provider 1902 and server 1904, or vice versa. The one or more networks 1908 will be discussed in more detail below with regard to FIG. 9.

In addition, the environment 1900 may also include one or more servers 1904. The one or more servers 1904 may generate, store, receive, and transmit any type of data, including digital assets 214, backing components 218, physical ST tokens 242, complete ST tokens 244, bank ST tokens 246, hybrid ST tokens 248, or other information. For example, a server 1904 may receive data from a client device, such as the client device 1906A, and send the data to another client device, such as the client device 1902B and/or 1902C. The server 1904 can also transmit electronic messages between one or more users of the environment 1900. In one example embodiment, the server 1904 is a data server. The server 1904 can also comprise a communication server or a web-hosting server. Additional details regarding the server 1904 will be discussed below with respect to FIG. 20.

As mentioned, in one or more embodiments, the one or more servers 1904 can include or implement at least a portion of the ST platform 200. In particular, ST platform 200 can comprise an application running on the one or more servers 1904, or a portion of ST platform 200 can be downloaded from the one or more servers 1904. For example, ST platform 200 can include a web hosting application that allows the client devices 1906A-1906C to interact with content hosted at the one or more servers 1904. To illustrate, in one or more embodiments of the environment 1900, one or more client devices 1906A-1906C can access a webpage supported by the one or more servers 1904. In particular, the client device 1906A can run a web application (e.g., a web browser) to allow a user to access, view, and/or interact with a webpage or website hosted at the one or more servers 1904.

Upon the client device 1906A accessing a webpage or other web application hosted at the one or more servers 1904, in one or more embodiments, the one or more servers 1904 can provide access to one or more ST tokens stored at the one or more servers 1904. Moreover, the client device 1906A can receive a request (i.e., via user input) to sell and/or modify an ST token and provide the request to the one or more servers 1904. Upon receiving the request, the one or more servers 1904 can automatically perform the methods and processes described above. The one or more servers 1904 can provide all or portions of the ST token information to the client device 1906A for display to the user.

As just described, the ST platform 200 may be implemented in whole, or in part, by the individual elements 1902-1908 of the computing environment 1900. It will be appreciated that although certain components of ST platform 200 are described in the previous examples with regard to particular elements of the computing environment 1900, various alternative implementations are possible. For instance, in one or more embodiments, ST platform 200 is implemented on any of the client devices 1906A-C. Similarly, in one or more embodiments, the ST platform 200 may be implemented on the one or more servers 1904. Moreover, different components and functions of the ST platform 200 may be implemented separately among client devices 1906A-1906C, the one or more servers 1904, and the network 1908.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (SSDs) (e.g., based on RAM), Flash memory, phase-change memory (PCM), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmission media can include a network and/or data links that can be used to carry desired program code means in the form of computer-executable instructions or data structures and which can be accessed by a general-purpose or special-purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special-purpose computer, or special-purpose processing device to perform a certain function or group of functions. In some embodiments, computer-executable instructions are executed on a general-purpose computer to turn the general-purpose computer into a special-purpose computer implementing elements of the disclosure. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including personal computers, desktop computers, laptop computers, message processors, handheld devices, multiprocessor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud computing model can also be deployed using different deployment models such as private cloud, community cloud, public cloud, hybrid cloud, and so forth. In this description and in the claims, a “cloud-computing environment” is an environment in which cloud computing is employed.

### Example Operating Environment

Having described an overview of embodiments of the present invention, an example operating environment in which some embodiments of the present invention are implemented is described below in order to provide a general context for various aspects of the present invention. Referring now to FIG. 20 in particular, an example operating environment for implementing embodiments of the present disclosure is shown and designated generally as computing device 2000. Computing device 2000 is but one example of a suitable computing environment and is not intended to suggest any limitation as to the scope of use or functionality of the invention. Neither should computing device 2000 be interpreted as having any dependency or requirement relating to any one or combination of components illustrated.

In some embodiments, the present techniques are embodied in computer code or machine-useable instructions, including computer-executable instructions such as program modules, being executed by a computer or other machine, such as a cellular telephone, personal data assistant or other handheld device. Generally, program modules (e.g., including or referencing routines, programs, objects, components, libraries, classes, variables, data structures, etc.) refer to code that perform particular tasks or implement particular abstract data types. Various embodiments are practiced in a variety of system configurations, including hand-held devices, consumer electronics, general-purpose computers, more specialty computing devices, etc. Some implementations are practiced in distributed computing environments where tasks are performed by remote-processing devices that are linked through a communications network.

FIG. 20 illustrates, in block diagram form, an exemplary computing device 2000 that can be configured to perform one or more of the processes described above. One will appreciate that one or more computing devices such as the computing device 2000 can implement the image processing system. As shown by FIG. 20, the computing device can include a processor 2002, memory 2004, one or more communication interfaces 2006, a storage device 2008, and one or more I/O devices/interfaces 2010. In certain embodiments, the computing device 2000 can include fewer or more components than those shown in FIG. 20. Components of computing device 2000 shown in FIG. 20 will now be described in additional detail.

In particular embodiments, processor(s) 2002 includes hardware for executing instructions, such as those making up a computer program. As an example, and not by way of limitation, to execute instructions, processor(s) 2002 can retrieve (or fetch) the instructions from an internal register, an internal cache, memory 2004, or a storage device 2008 and decode and execute them. In various embodiments, the processor(s) 2002 can include one or more central processing units (CPUs), graphics processing units (GPUs), field programmable gate arrays (FPGAs), systems on chip (SOC), or other processor (s) or combinations of processors.

The computing device 2000 includes memory 2004, which is coupled to the processor(s) 2002. The memory 2004 can be used for storing data, metadata, and programs for execution by the processor (s). The memory 2004 can include one or more of volatile and non-volatile memories, such as Random Access Memory (“RAM”), Read Only Memory (“ROM”), a solid-state disk (“SSD”), Flash, Phase Change Memory (“PCM”), or other types of data storage. The memory 2004 can be internal or distributed memory.

The computing device 2000 can further include one or more communication interfaces 2006. A communication interface 2006 can include hardware, software, or both. The communication interface 2006 can provide one or more interfaces for communication (such as, for example, packet-based communication) between the computing device and one or more other computing devices 1100 or one or more networks. As an example, and not by way of limitation, communication interface 1106 can include a network interface controller (“NIC”) or network adapter for communicating with an Ethernet or other wire-based network or a wireless NIC (“WNIC”) or wireless adapter for communicating with a wireless network, such as a WI-FI. The computing device 2000 can further include a bus 2012. The bus 2012 can comprise hardware, software, or both that couples components of computing device 2000 to each other.

The computing device 2000 includes a storage device 2008 includes storage for storing data or instructions. As an example, and not by way of limitation, storage device 2008 can comprise a non-transitory storage medium described above. The storage device 2008 can include a hard disk drive (“HDD”), flash memory, a Universal Serial Bus (“USB”) drive or a combination these or other storage devices. The computing device 2000 also includes one or more input or output (“I/O”) devices/interfaces 2010, which are provided to allow a user to provide input to (such as user strokes), receive output from, and otherwise transfer data to and from the computing device 2000. These I/O devices/interfaces 2010 can include a mouse, keypad or a keyboard, a touch screen, camera, optical scanner, network interface, modem, other known I/O devices or a combination of such I/O devices/interfaces 2010. The touch screen can be activated with a stylus or a finger.

The I/O devices/interfaces 2010 can include one or more devices for presenting output to a user, including, but not limited to, a graphics engine, a display (e.g., a display screen), one or more output drivers (e.g., display drivers), one or more audio speakers, and one or more audio drivers. In certain embodiments, I/O devices/interfaces 2010 is configured to provide graphical data to a display for presentation to a user. The graphical data can be representative of one or more graphical user interfaces and/or any other graphical content as can serve a particular implementation.

Having identified various components in the present disclosure, it should be understood that any number of components and arrangements can be employed to achieve the desired functionality within the scope of the present disclosure. For example, the components in the embodiments depicted in the figures are shown with lines for the sake of conceptual clarity. Other arrangements of these and other components can also be implemented. For example, although some components are depicted as single components, many of the elements described herein can be implemented as discrete or distributed components or in conjunction with other components, and in any suitable combination and location. Some elements can be omitted altogether. Moreover, various functions described herein as being performed by one or more entities can be carried out by hardware, firmware, and/or software, as described below. For instance, various functions can be carried out by a processor executing instructions stored in memory. As such, other arrangements and elements (e.g., machines, interfaces, functions, orders, and groupings of functions, etc.) can be used in addition to or instead of those shown.

The subject matter of the present invention is described with specificity herein to meet statutory requirements. However, the description itself is not intended to limit the scope of this patent. Rather, the inventor has contemplated that the claimed subject matter might also be embodied in other ways, to include different steps or combinations of steps similar to the ones described in this document, in conjunction with other present or future technologies. Moreover, although the terms “step” and/or “block” can be used herein to connote different elements of methods employed, the terms should not be interpreted as implying any particular order among or between various steps herein disclosed unless and except when the order of individual steps is explicitly described. For purposes of this disclosure, words such as “a” and “an,” unless otherwise indicated to the contrary, include the plural as well as the singular. Thus, for example, the requirement of “a feature” is satisfied where one or more features are present.

The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and can be employed without reference to other features and subcombinations. This is contemplated by and is within the scope of the claims.

What is claimed is:

1. A system for token creation containing a backing component, the system comprising:
at least one processor; and
one or more computer storage media storing computer executable instructions that when executed by the at least one processor, cause the at least one processor to perform operations comprising:
obtaining a digital asset for conversion to a token with a backing component, wherein the digital asset is a digital artwork;
collecting the backing component for the digital asset;
creating a smart contract associated with the digital asset, wherein the smart contract links the backing component for the digital asset; and
generating the token via tokenization of the digital asset, the backing component, and the smart contract.

2. The system of claim 1, wherein the backing component is a physical asset held in escrow by a third-party provider.

3. The system of claim 1, wherein the backing component is a banking mechanism configured to store funds provided by a sale of the token.

4. The system of claim 3, wherein a percentage of the sale of the token is deposited into the banking mechanism as dictated by the smart contract.

5. The system of claim 1, wherein the backing component includes a physical asset held in escrow by a third-party provider and a banking mechanism configured to store funds provided by a sale of the token.

6. The system of claim 1, wherein the smart contract includes terms for accessing the backing component of the token.

7. The system of claim 1, wherein the backing component is a banking mechanism configured to store funds provided by a sale of the token and the smart contract includes terms for acquiring additional backing components for the token.

8. The system of claim 1, further comprising:
receiving a digital asset addition request;
verifying a banking mechanism used as the backing component contains sufficient funds set forth in the smart contract;
withdrawing a portion of funds stored by the banking mechanism;
utilizing the portion of the withdrawn funds to acquire an additional digital asset; and
updating the smart contract of the token with the additional digital asset.

9. The system of claim 1, further comprising:
receiving a digital asset upgrade request;
verifying a banking mechanism used as the backing component contains sufficient funds set forth in the smart contract;
withdrawing a portion of funds stored by the banking mechanism;
utilizing the portion of the withdrawn funds to acquire an upgraded digital asset; and
updating the token with the upgraded digital asset.

10. The system of claim 1, further comprising:
receiving a physical asset addition request;
verifying a banking mechanism used as the backing component contains sufficient funds set forth in the smart contract;
withdrawing a portion of funds stored by the banking mechanism;
utilizing the portion of the withdrawn funds to acquire an additional physical asset;
storing the additional physical asset in a vault; and
updating the smart contract of the token to indicate the presence of the additional physical asset.

11. The system of claim 1, further comprising:
receiving a physical asset upgrade request;
verifying a banking mechanism used as the backing component contains sufficient funds set forth in the smart contract;
withdrawing a portion of funds stored by the banking mechanism;
facilitating a sale of a physical asset used as the backing component for the token;
utilizing the portion of the withdrawn funds and additional funds from the sale of the physical asset to acquire an upgraded physical asset;
storing the upgraded physical asset in a vault; and
updating the smart contract of the token to indicate a presence of the upgraded physical asset.

12. A method comprising:
receiving a sale request relating to a token on a platform, wherein the token includes a backing component;
verifying the sale request between an owner of the token and a recipient of the sale request;
determining a sale requirement set forth in a smart contract associated with the token is achieved;
upon verifying the sale request and determining the sale requirement is met, transferring at least a portion of agreed upon funds relating to the sale request to the owner; and
transferring ownership of the token to the recipient.

13. The method of claim 12, wherein the backing component is a physical asset held in escrow by a third-party provider.

14. The method of claim 12, wherein the backing component is a banking mechanism configured to store funds provided by a sale of the token.

15. The method of claim 12, wherein the backing component includes a physical asset held in escrow by a third-party provider and a banking mechanism configured to store funds provided by a sale of the token.

16. A computer program product for retrieval of a backing component associated with a token, the computer program product comprising a computer readable storage medium having computer readable instructions stored therein, wherein the computer readable instructions, when executed on a computing device, causes the computing device to:
receive a request from an owner of a token, wherein the request relates to a retrieval of a backing component associated with the token;
verify a retrieval requirement set forth in a smart contract associated with the token is achieved;
destroy the token;
retrieve an asset acting as the backing component for the token; and
provide the asset to the owner.

17. The computer program product of claim 16, wherein the backing component is a physical asset held in escrow by a third-party provider.

18. The computer program product of claim 17, wherein the backing component include an additional physical asset also held in escrow by the third-party provider.

19. The computer program product of claim 16, wherein the backing component is a banking mechanism configured to store funds provided by a sale of the token.

20. The computer program product of claim 16, wherein the backing component includes a physical asset held in escrow by a third-party provider and a banking mechanism configured to store funds provided by a sale of the token.
